(19) United States
(12) Patent Application Publication
(10) Pub. No.: US 2025/0381517 A1
(43) Pub. Date: Dec. 18, 2025

(54) Methods Of Carbon Capture, And Compositions And Systems For Same

(71) Applicant: Cornell University, Ithaca, NY (US)

(72) Inventors: Tristan H. Lambert, Lansing, NY (US); Phillip J. Milner, Ithaca, NY (US); Sijing Meng, Ithaca, NY (US)

(21) Appl. No.: 19/237,292

(22) Filed: Jun. 13, 2025

Related U.S. Application Data
(60) Provisional application No. 63/659,801, filed on Jun. 13, 2024.

(51) Int. Cl. B01D 53/14

(52) U.S. Cl. CPC B01D 53/1475; B01D 53/1412; B01D 53/1425; B01D 53/1493; B01D 2252/20431; B01D 2257/504; B01D 2258/0283

(57) ABSTRACT

Methods, compositions, and systems for carbon capture. In various examples, a carbon source, for example, carbon dioxide (CO₂), is separated, captured, sequestered, stored, or any combination thereof. A composition comprises tertiary amine N-oxide(s) and/or tertiary amine N-oxide group(s), which may be attached to, for example, a solid sorbent material, for example a polymeric material, an amorphous material, or a crystalline material, which may be porous. In various examples, CO₂ is contacted with one or more composition(s), water, and optionally co-solvent(s), where CO₂ carbon dioxide is separated, captured, sequestered, stored, or any combination thereof. In various examples, a system (e.g., a CO₂ scrubber) comprising one or more composition(s) in fluid and/or gas connection to one or more emission stream(s) (e.g., waste emission, industrial emission, product emission, or any combination thereof) comprising an undesirable amount of CO₂ is configured to remove at least a portion of the CO₂ from the emission stream(s).

### CROSS-REFERENCE TO RELATED APPLICATIONS

This application claims the benefit of U.S. Provisional Patent Application No. 63/659,801, filed Jun. 13, 2024 and titled “Methods of Carbon Capture, and Compositions and Systems for Same.” The entire contents of the above-identified priority application are hereby fully incorporated herein by reference in their entirety.

### STATEMENT REGARDING FEDERALLY SPONSORED RESEARCH

This invention was made with government support under contract no. DE-SC0021000 awarded by the U.S. Department of Energy. The government has certain rights in the invention.

### BACKGROUND OF THE DISCLOSURE

Following current trends in greenhouse gas emissions, the average temperature of the Earth's surface will inevitably warm by 1.5° C., the global limit agreed to under the 2015 Paris Agreement, 1 by as early as 2034. Due to this urgent situation, carbon capture and sequestration (CCS) from fossil fuel-fired power plants and related hard-to-abate sectors plays a key role during clean energy transition to reach international climate targets. Although global CCS deployment has bloomed in recent years to reach a capacity of ˜50 Mt CO₂ captured and stored annually, this amount only accounts for 0.6% of the value needed (greater than 8 Gt) to achieve net zero CO₂ emissions, consistent with the Paris Agreement 1.5° C. limit, by 2050. Clearly, this disparity requires a large expansion of CCS deployment worldwide to meet the climate mitigation targets over the coming decades.

Since their conception nearly a century ago, 7 aqueous amine scrubbers have emerged as the most technology-ready system for CCS. The first-generation technology using monoethanolamine (MEA) and later advances using secondary/tertiary amines demonstrate high selectivity for CO₂ via reversible ammonium carbamate formation under dry conditions and ammonium bicarbonate (HCO₃⁻) and/or carbonate (CO₃²⁻) formation under humid conditions. However, amines suffer from several critical drawbacks that hinder their wide-spread deployment. First, high regeneration temperatures (greater than 100° C.) are needed in temperature-swing processes, which not only account for 70-80% of the total energy cost for continuous scrubber operation but also lead to significant thermal and oxidative amine degradation into over 100 reported products in the presence of oxygen and leached metal ions. The decomposition of amines, which is hard to avoid due to their highly electron-rich, nucleophilic, and basic nature, necessitates continuous replacement, complex reclaiming processes, and adds an additional 10% to the overall cost of carbon capture systems. Second, amines are toxic, volatile, and corrosive, which presents challenges regarding their safe handling on multi-ton scale. As such, alternatives to amines that maintain their reactivity-based selectivity for CO₂ while also demonstrating improved stability and reduced corrosiveness, volatility, and toxicity, would greatly accelerate the global adoption of CCS.

One oxidation product of tertiary amines—potentially relevant to carbon capture processes—are the corresponding trialkylamine N-oxides. The formation of N-oxides would normally be considered a dead-end for the reactivity towards carbon capture due to the loss of the nucleophilic and basic nitrogen center.

### SUMMARY OF THE DISCLOSURE

The present disclosure provides, inter alia, methods of carbon capture. The present disclosure also provides compositions and systems.

In various examples, the present disclosure provides methods of carbon capture. In various examples, a method of separating, capturing, sequestering, storing, or the like, or any combination thereof, carbon dioxide (CO₂), one or more structural analog(s) thereof, or the like, or a combination thereof comprises contacting, which may be repeated a desired number of times, a gas comprising the CO₂, the one or more structural analog(s) thereof, or the like, or the combination thereof or a liquid comprising the CO₂, the one or more structural analog(s) thereof, or the like, or the combination thereof one or more capture sorbent(s) independently comprising one or more tertiary amine N-oxide(s) and/or one or more tertiary amine N-oxide group(s) and optionally, water, where at least a portion, substantially all, or all of the CO₂, the one or more structural analog(s) thereof, or the combination thereof is separated, captured, sequestered, or stored, or any combination thereof. Non-limiting examples of capture sorbents and tertiary amine N-oxides and tertiary amine N-oxide group are disclosed herein. In various examples, one or more or all of the capture sorbent(s) comprises the one or more tertiary amine N-oxide group(s) attached to at least a portion, substantially all, or all of one or more solid material(s), such as, for example, one or more polymeric material(s), one or more amorphous material(s), one or more crystalline material(s), or the like, or any combination thereof. In various examples, one or more or all of the solid material(s) is/are porous solid material(s). Non-limiting examples of solid materials, which may be porous solid materials, are disclosed herein. In various examples, the one or more tertiary amine N-oxide(s) and/or the one or more tertiary amine N-oxide group(s) is/are formed prior to or during one or more or all of the contacting(s). In various examples, the contacting(s) independently comprises contacting the gas comprising the CO₂, the structural analog(s) thereof, or the combination thereof or a liquid comprising the CO₂, the structural analog(s) thereof, or the combination thereof with optionally, the water and optionally, the one or more co-solvent(s). In various examples, the gas comprising the CO₂, the structural analog(s) thereof, or the combination thereof is a waste gas, an industrial gas, or any combination thereof or the liquid comprising the CO₂, the structural analog(s) thereof, or the combination thereof is a waste stream, an industrial stream, or any combination thereof.

In various examples, the present disclosure provides compositions. In various examples, a composition is a capture sorbent composition or the like. In various examples, a composition (which may be a capture sorbent composition or the like) comprises one or more tertiary amine N-oxide(s) and/or one or more tertiary amine N-oxide group(s). Non-limiting examples of tertiary amine N-oxides and tertiary amine N-oxide group are disclosed herein. In various examples, at least a portion, substantially all, or all of the one or more tertiary amine N-oxide group(s) is/are attached to at least a portion, substantially all, or all of one or more surface(s) of one or more solid material(s), such as, for example, one or more polymeric material(s), one or more amorphous material(s), one or more crystalline material(s), or the like, or any combination thereof. In various examples, one or more or all of the solid material(s) is/are porous solid material(s). Non-limiting examples of solid materials, which may be porous solid materials, are disclosed herein. In various examples, a composition (which may be a capture sorbent composition or the like) further comprises water, and optionally, one or more co-solvent(s).

In various examples, the present disclosure provides systems. In various examples, a system for separating, capturing, sequestering, storing, or the like, or any combination thereof, carbon dioxide (CO₂), one or more structural analogs thereof, or any combination thereof, comprises one or more composition(s) of the present disclosure, one or more or all of which may be capture sorbent composition(s) of the present disclosure. In various examples, the system is a CO₂ scrubbing unit or the like. In various examples, the one or more composition(s) is/are in fluid and/or gas connection to one or more emission stream(s) comprising the CO₂, the one or more structural analogs thereof, or the combination thereof. In various examples, the system is configured to operate in a continuous flow mode, a semi-continuous flow mode, a batch mode, or the like, or any combination thereof.

This disclosure includes, inter alia, a new type of sorbent for applications in carbon capture and separations. Capture sorbents of the present disclosure are distinguished by their desirable thermal and chemical stability, for example, when compared to traditional sorbents such as, for example, amines. The capture sorbents possess similar structural tunability and adaptility to incorporation, for example, into polymeric materials as amines, making them a promising new platform, for example, for challenging separations. In various examples, it was demonstrated that oxidation of trialkylamines to the corresponding trialkylamine N-oxides does not preclude their use for carbon capture, such as, for example, weakly-basic, environmentally-friendly MMNO is capable of binding CO₂, for example, in the presence of water (e.g., under humid conditions or the like) or the like, via the formation of a hydrogen-bond-stabilized HCO₃⁻ species. In addition, MMNO exhibited desirable oxidative and thermal stability under tested conditions, is minimally volatile, and, in various examples, releases CO₂ at room temperature in a vacuum swing process and about 85° C. in a temperature-swing process.

### BRIEF DESCRIPTION OF THE FIGURES

For a fuller understanding of the nature and objects of the disclosure, reference should be made to the following detailed description taken in conjunction with the accompanying figures.

FIG. 1 shows CO₂ capture using 4-methylmorpholine N-oxide (MMNO) hydrate. The MMNO exhibits desirable oxidative stability, thermal stability, volatility, and toxicity.

FIG. 2 shows (a) ¹³C{¹H} NMR spectra of ¹³CO₂-dosed MMNO (0.25 M, DMSO-D₆) with different equivalents of water, control experiments with no MMNO, and after N₂ purging for 1 hour. (b)¹H NMR spectra of NMR titration experiments of MMNO (host, 0.25 M in DMSO-D₆) and water (guest, 0, 0.5, 1, 2, 3, 4, 5, 10, 20 equivalents). Hₐ, H_{b}, H_{c}, H_{d} for MMNO were tracked for perturbation. See Supporting Information for experiments with other host concentrations. (c) 2D NOESY spectrum of MMNO (0.25 M, DMSO-D₆) with 1 equivalent of water at 25° C. at a mixing time of 600 ms (ms=millisecond(s)). (d) 2D NOESY spectrum of MMNO (0.25 M, DMSO-D₆) with 20 equivalents of water at 25° C. at a mixing time of 600 ms. (e) A plausible mechanism (1:2 full model) of MMNO—H₂O host-guest binding determined from the NMR titration experiments via NMR data fitting using nonlinear regression methods, and association constants (K₁ and K₂). Numbers are reported as “average±standard error” among three experiments with different host concentrations.

FIG. 3 shows (a) ¹³C{¹H} spectrum of MMNO (0.25 M, DMSO-D₆) dosed with ¹³CO₂ with different equivalents of water. (b) Mole fractions of new ¹³C═O species (versus total ¹³C species) from the integrations and mole fractions of free MMNO, MMNO·H₂O, and MMNO·(H₂O)₂ (versus total MMNO species) from the output parameters of the NMR titration data fitting. (c) ¹³C{¹H} spectrum of MMNO (D₂O) dosed with ¹³CO₂ with different concentrations, and corresponding equivalents of water. (d)¹H NMR spectrum of 4 equivalents of water (DMSO-D₆) without and with 1 equivalent of MMNO (0.25 M), and with both MMNO and ¹³CO₂. (e) A comparison of the ¹³C NMR chemical shift in D₂O for the product detected in this Example (“This work”) with other common (bi)carbonate compounds in D₂O. Observed ¹³C chemical shifts for K⁺ mixtures (“75% HCO₃⁻” and “75% CO₃²⁻”) only showed single chemical shifts due to the fast exchange of the proton between KHCO₃ and K₂CO₃.⁴¹ (f) pH before and after pure water and 0.25 M aqueous MMNO solution were equilibrated with CO₂ bubbling for 11 min at room temperature (21-22° C.).

FIG. 4 shows Density Functional Theory (DFT)-calculated enthalpy changes and optimized geometries of MMNO and its hydrates, along with three different proposed structures for the product (1, 2, and 3). Calculated ¹³C NMR chemical shifts for C═O carbons in 1-3 compared to the observed chemical shift (both in DMSO(-D₆) as the solvent).

FIG. 5 shows (a) the in situ infrared (IR) spectrum of 1:4 (v:v) 50 wt. % MMNO(aq):DMSO before CO₂ bubbling, after CO₂ (100%) bubbling (absorption) and after N₂ bubbling (desorption). Stretches at 1716 and 1656 cm⁻¹ are assigned to the product(s). (b) IR trend tracking for stretches 1716 and 1656 cm⁻¹ of CO₂ (100%) absorption-desorption cycles 4-7 at 6 sccm using 1:4 (v:v) 50 wt. % MMNO(aq):DMSO at room temperature (21-22° C.). (c) The CO₂ capacity trend of one CO₂ absorption-desorption cycle with 1:4 (v:v) 50 wt. % MMNO(aq):DMSO using 100%, 50%, 15% CO₂ in N₂ mixtures, and flue gas (9.7% CO₂) from Cornell University's natural gas-fired power plant (9.7% CO₂) at 6 sccm at room temperature (21-22° C.). (d) Appearances after accelerated aging studies for MMNO, 4-methylmorpholine (MM), 1-methylpiperazine (MP), and monoethanolamine (MEA) with heating at 100° C. for 1 week in D₂O or DMSO-D₆ under flue gas.

FIG. 6 shows a scheme of experimental setup for in situ IR measurements for CO₂ dosing.

FIG. 7 shows 3D surface of in situ IR measurements data with 100% CO₂ (first plot), peak trends (height of peaks over a 2-point baseline) of 1656 cm⁻¹ and 1716 cm⁻¹ for cycles 1-7 (second plot), and IR spectra of cycle 7 absorption (third plot) using 100% CO₂ and desorption (fourth plot) using N₂. For visualization, the data were reduced to 1 spectrum/min, instead of 1 spectrum/15 s (s=second(s)) for the third and fourth plots.

FIG. 8 shows IR spectra of the cycle of absorption (top) and desorption (bottom) of CO₂ using 50% CO₂ in N₂. For visualization, the data were reduced to 1 spectrum/min.

FIG. 9 shows IR spectra of the cycle of absorption (top) and desorption (bottom) of CO₂ using 15% CO₂ in N₂. For visualization, the data were reduced to 1 spectrum/min.

FIG. 10 shows IR spectra of the cycle of absorption (top) and desorption (bottom) of CO₂ using flue gas (9.7% CO₂). For visualization, the data were reduced to 1 spectrum/min.

FIG. 11 shows variable temperature (VT) ¹³C{¹H} NMR spectra of ¹³CO₂-dosed 1 M MMNO solution with 5 equivalents of water in DMSO-D₆. VT measurements were performed with an air-tight screw-cap NMR tube under ˜1 atm of ¹³CO₂. These spectra show that the equilibrium lies almost completely on the side of the free-dissolved ¹³CO₂ above 65° C. This would indicate that a low regeneration temperature (˜65° C.) is desirable to desorb CO₂ from MMNO in a temperature swing process. These spectra also confirm that MMNO is stable under a CO₂ atmosphere at temperatures up to at least 125° C., as no new ¹³C NMR resonances were observed upon heating. By integrating the peaks corresponding to chemisorbed ¹³CO₂ (˜160 ppm) and physisorbed ¹³CO₂ (˜125 ppm) at 25° C. and 45° C. and assuming the total amount of ¹³CO₂ does not change (integration of 23535.26 in total at 25° C. and 22799.09 at 45° C.), the amount of chemisorbed ¹³CO₂ decreased by ˜20% upon heating from 25° C. to 45° C.

FIG. 12 shows viscosities of 1:4 (v:v) 50 wt % MMNO(aq):DMSO with a shear rate of 300 s⁻¹ at temperatures of 25, 45, 65, and 85° C. before and after CO₂ bubbling of 1.5 hours. CO₂ absorption does not significantly affect the viscosity of the solution.

FIG. 13 shows in situ pH measurements of pure water and aqueous MMNO solution (0.25 M, both 6 mL) when bubbling 100% CO₂ through the solutions.

FIG. 14 shows activation tests for MOF-808-HOHOH, and N-oxide-appended MOFs (MOF-808-HOHOH-TMANO/QNO/MPNO/MPYNO/MMNO).

FIG. 15 shows CO₂ uptake profiles at specific activation temperatures for MOF-808-HOHOH, and N-oxide-appended MOFs (MOF-808-HOHOH-TMANO/QNO/MPNO/MPYNO/MMNO).

FIG. 16 shows cyclability tests at specific activation temperature (40° C.) for and N-oxide-appended MOFs (MOF-808-HOHOH-TMANO/QNO/MPNO/MPYNO/MMNO).

FIG. 17 shows CO₂ uptake profiles for various CO₂ concentrations at specific activation temperatures for MOF-808-HOHOH and MOF-808-HOHOH-TMANO.

### DETAILED DESCRIPTION OF THE DISCLOSURE

Although claimed subject matter will be described in terms of certain examples, examples, including examples that do not provide all of the benefits and features set forth herein, are also within the scope of this disclosure. For example, various structural, logical, process steps, and electronic changes may be made without departing from the scope of the disclosure.

As used herein, unless otherwise stated, “about,” “approximately,” “substantially,” or the like, when used in connection with a measurable variable such as, for example, a parameter, an amount, a temporal duration, or the like, are meant to encompass variations of, for example, a specified value including, for example, those within experimental error (which can be determined by for example, a given data set, an art accepted standard, and/or with a given confidence interval (e.g., 90%, 95%, or more confidence interval from the mean), such as, for example, variations of +/−10% or less, +1-5% or less, +/−1% or less, and +/−0.1% or less of and from the specified value) or to encompass alternatives to the members of the list that would be recognized by one of ordinary skill in the art as alternatives, where the members and the alternatives may define a genus or sub-genus, insofar as such variations are appropriate to perform in the context of the disclosure. As used herein, unless otherwise stated, the terms “about,” “approximate,” “at or about,” “substantially,” and “˜” can mean that the amount or value in question can be the exact value or a value that provides equivalent results or effects as recited in the sample claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art such that, for example, equivalent results, effects, or the like are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” “at or about,” or “˜” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also, unless otherwise stated, include individual values (e.g., about 1%, about 2%, about 3%, and about 4%) and the sub-ranges (e.g., about 0.5% to about 1.1%; about 0.5% to about 2.4%; about 0.5% to about 3.2%, and about 0.5% to about 4.4%, and other possible sub-ranges) within the indicated range. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about”, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent radicals, trivalent radicals, and the like). Illustrative examples of groups include:

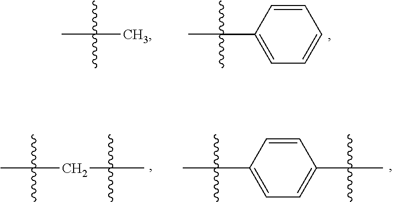

and the like.

As used herein, unless otherwise stated, the term “alkyl group” refers to branched or unbranched hydrocarbon groups that include only single bonds between carbon atoms (not including substituent(s), if any). In various examples, an alkyl group is a C₁ to C₁₂ alkyl group, including all integer numbers of carbons and ranges of numbers of carbons therebetween (e.g., C₁, C₂, C₃, C₄, C₅, C₆, C₇, C₈, C₉, C₁₀, C₁₁, or C₁₂). In various examples, an alkyl group is a saturated group. In various examples, an alkyl group is a cyclic alkyl group, e.g., a monocyclic alkyl group or a polycyclic alkyl group or the like. Examples of alkyl groups include, but are not limited to, methyl groups, ethyl groups, propyl groups, butyl groups, isopropyl groups, tert-butyl groups, cyclohexyl groups, and adamantyl groups, and the like. In various examples, an alkyl group is unsubstituted or substituted with one or more substituent(s). Examples of substituents include, but are not limited to, various substituents such as, for example, halide groups (—F, —Cl, —Br, and —I), aliphatic groups (e.g., alkyl groups, alkenyl groups, alkynyl groups, and the like), halogenated aliphatic groups (e.g., trifluoromethyl group and the like), aryl groups, halogenated aryl groups, hydroxyl group, amine groups, nitro group, cyano groups, isocyano groups, silane groups (e.g., alkyl silane groups, aryl silane groups, alkyl/aryl silane groups, or the like), alkoxide groups, alcohol groups, ether groups, ketone groups, carboxylate groups, carboxylic acid groups, ester groups, amide groups, thioether groups, carbamate groups, carboxylic acid groups, and the like, and any combination thereof.

As used herein, unless otherwise stated, the term “cyclic group” refers to branched or unbranched hydrocarbons, which may be saturated or unsaturated (e.g., comprising at least one carbon-carbon double bond or the like.) In various examples, a cyclic group is a monocyclic group or a polycyclic group. In various examples, a cyclic group (which may be referred to as a heterocyclic group) comprises one or more heteroatom(s) in a ring or rings, if present, of the cyclic group, such as, for example, oxygen, nitrogen (e.g., pyridinyl groups and the like), sulfur, and the like, and any combination thereof.

As used herein, unless otherwise indicated, the term “aryl group” refers to C₅ to C₃₀ aryl or partially aromatic carbocyclic groups, including all integer numbers of carbons and ranges of numbers of carbons therebetween (e.g., C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, and C₃₀). In various examples, an aryl group is a polyaryl group, such as, for example, a polyaryl group comprising two or more fused aryl rings, biraryl groups, or a combination thereof. In various examples, an alkenyl group is unsubstituted or substituted with one or more substituent(s). Examples of substituents include, but are not limited to, various substituents such as, for example, halide groups (—F, —Cl, —Br, and —I), hydroxyl groups, amine groups, nitro groups, cyano groups, isocyano groups, alkoxide groups, alcohol groups, ether groups, ketone groups, carboxylate groups, carboxylic acid groups, ester groups, amide groups, thioether groups, and the like, and any combination thereof. Examples of aryl groups include, but are not limited to, phenyl groups, biaryl groups (e.g., biphenyl groups and the like), fused ring groups (e.g., naphthyl groups and the like), hydroxybenzyl groups, tolyl groups, xylyl groups, furanyl groups, benzofuranyl groups, indolyl groups, imidazolyl groups, benzimidazolyl groups, pyridinyl groups, and the like. In various examples, an aryl group (which may be referred to as a heteroaryl group) comprises one or more heteroatom(s) in the ring or rings, if present, of the aryl group, such as, for example, oxygen, nitrogen (e.g., pyridinyl groups and the like), sulfur, and the like, and any combination thereof. Examples of aryl groups include, but are not limited to, phenyl groups, biaryl groups (e.g., biphenyl groups and the like), fused ring groups (e.g., naphthyl groups and the like), hydroxybenzyl groups, tolyl groups, xylyl groups, furanyl groups, benzofuranyl groups, indolyl groups, imidazolyl groups, benzimidazolyl groups, pyridinyl groups, and the like.

As used herein, unless otherwise stated, the term “structural analog” refers to any reactant (e.g., carbon dioxide or the like), composition component (e.g., tertiary amine N-oxide, tertiary amine N-oxide group, tertiary amine, tertiary amine group, or functional group thereof, or the like), or the like, or any portion thereof (such as, for example, one or more group(s) thereof or the like) if one atom or group of atoms, functional group or functional groups, or substructure or substructures is/are replaced with another atom or group of atoms, functional group or functional groups, substructure or substructures, or the like. In various examples, the term “structural analog” refers to any group that is derived from an original reactant (e.g., carbon dioxide or the like), composition component (e.g., tertiary amine N-oxide, tertiary amine N-oxide group, tertiary amine, tertiary amine group, or functional group thereof, or the like), or the like, or any portion thereof (such as, for example, one or more group(s) thereof or the like) or the like by a chemical reaction, where the reactant (e.g., the carbon dioxide or the like), the composition component (e.g., the tertiary amine N-oxide, the tertiary amine N-oxide group, the tertiary amine, the tertiary amine group, or the functional group thereof, or the like), or the like, or the portion thereof (such as, for example, the one or more group(s) thereof or the like) is modified or partially substituted such that at least one structural feature of the reactant (e.g., the carbon dioxide or the like), the composition component (e.g., the tertiary amine N-oxide, the tertiary amine N-oxide group, the tertiary amine, the tertiary amine group, or the functional group thereof, or the like), or the like, or the portion thereof (such as, for example, the one or more group(s) thereof or the like) is retained.

The present disclosure provides methods of carbon capture. The present disclosure also provides compositions and systems.

In an aspect, the present disclosure provides methods of carbon capture. In various examples a method comprises capturing (such as, for example, separating, capturing, sequestering, storing, or the like, or any combination thereof), a carbon source or sources (such as, for example, carbon dioxide, a structural analog or analogs thereof, or the like, or any combination thereof). In various examples, a method comprises contacting a carbon source or sources (such as, for example, carbon dioxide, a structural analog or analogs thereof, or the like, or any combination thereof) (e.g., a gas or liquid comprising carbon dioxide or the like), with one or more capture sorbent(s) comprising one or more tertiary amine N-oxide(s) and/or one or more tertiary amine N-oxide group(s) and optionally, water. In various examples, a method uses a composition of the present disclosure, a system of the present disclosure, or both. Non-limiting examples of methods are disclosed herein.

In various examples, a method of carbon capture (such as, for example, separating, capturing, sequestering, storing, or the like, or any combination thereof, a carbon source or sources (such as, for example, carbon dioxide (CO₂) (e.g., carbon dioxide gas, a liquid comprising CO₂, or the like), structural analog(s) thereof, or the like, or any combination thereof) comprises: contacting the carbon source or sources one or more capture sorbent(s) comprising one or more tertiary amine N-oxide(s) and/or one or more tertiary amine N-oxide group(s) (e.g., a composition or compositions of the present disclosure and/or in a system of the present disclosure) with optionally, water, and, optionally, one or more solvent(s) (which may be referred to as co-solvents). In various examples, at least a portion, substantially all, or all of the carbon source(s) (such as, for example, carbon dioxide (CO₂) (e.g., carbon dioxide gas, a liquid comprising CO₂, or the like, or the like), structural analog(s) thereof, or the like, or any combination thereof) is/are separated, captured, sequestered, stored, or the like, or any combination thereof.

A method can separate, capture, sequester, store, or the like, or any combination thereof various carbon sources. In various examples, a carbon source is a carbon-containing compound or the like. Non-limiting examples of carbon sources include carbon dioxide (such as, for example, carbon dioxide gas, a liquid comprising carbon dioxide gas, or the like), a structural analog or analogs thereof, or the like, or any combination thereof). In various examples, a method captures, sequesters, stores, or the like, or any combination thereof captures carbon dioxide (CO₂) (e.g., carbon dioxide gas or a liquid comprising carbon dioxide or the like), carbonic acid (H₂CO₃), bicarbonate (HCO₃⁻), or any combination thereof. In various examples, a carbon source compound is formed in situ.

A carbon source or sources may be present in a gas stream. In various examples, a gas comprising carbon source(s) (such as, for example, a gas comprising carbon dioxide (e.g., a gas atmosphere, a gas stream, or the like, or any combination thereof) is a waste gas, an industrial gas (e.g., an industrial waste gas, an industrial product gas, or the like, or any combination thereof), or the like, or any combination thereof. A carbon source or sources may be present in a liquid. In various examples, a liquid comprising a carbon source or sources (such as, for example, a liquid comprising carbon dioxide, which may be dissolved in the liquid) is a waste stream, an industrial stream (e.g., an industrial waste stream, an industrial product stream, or the like, or any combination thereof), or the like, or any combination thereof.

A capture sorbent comprises one or more tertiary amine N-oxide(s), one or more group(s) independently comprising (or formed from) a tertiary amine N-oxide group, or any combination thereof (tertiary amine N-oxide groups) or a hydrate or hydrates thereof. In various examples, a tertiary N-oxide group comprises (is derived from or formed from) a tertiary amine N-oxide (such as, for example, a tertiary amine N-oxide of the present disclosure). In various examples, a tertiary amine N-oxide group is a structural analog of a tertiary N-oxide (such as, for example, a tertiary amine N-oxide of the present disclosure). In various examples, tertiary amine N-oxide group(s) is/are independently derived from a tertiary amine N-oxide. In various examples, a capture sorbent comprises at least two or more different (e.g., structurally different or the like) tertiary amine N-oxide(s) and/or tertiary amine N-oxide groups. Without intending to be bound by any particular theory, it is considered that a tertiary amine N-oxide, or a tertiary amine N-oxide group, or tertiary amine, or the like stabilizes a carbon source (such as, for example, a carbon-containing compound (e.g., carbonic acid (H₂CO₃), bicarbonate (HCO₃⁻), or the like, or any combination thereof)), which influences the equilibrium in an absorption reaction (e.g., drives an absorption reaction forward).

In various examples, a method (e.g., a method of separating, capturing, sequestering, storing, or the like, or any combination thereof) carbon dioxide (e.g., by a method of the present disclosure) comprises a reaction between water (H₂O) and carbon dioxide (CO₂) (e.g., a reaction activated by one or more tertiary amine N-oxide(s)). In various examples, a reaction between water and carbon dioxide comprises formation of carbonic acid (H₂CO₃), bicarbonate (HCO₃⁻), and/or a mixture thereof. In various examples, a reaction (which may be referred to, in the alternative, as absorption or an absorption reaction) between water and carbon dioxide in the presence of (e.g., in contact with, such as, for example, in solution with) one or more tertiary amine N-oxide(s), forms carbonic acid (H₂CO₃), bicarbonate (HCO₃⁻), and/or a mixture thereof. In various examples, an absorption reaction results in the separation, capture, sequestration, storage, or the like, or any combination thereof, of carbon dioxide. In various examples, a method comprises an absorption reaction.

In various examples, a tertiary amine N-oxide or a tertiary amine N-oxide group is (or comprises) the following structure:

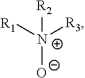

a structural analog thereof or a hydrate thereof. In various examples, R₁ is chosen from —H, alkyl groups (e.g., substituted and unsubstituted alkyl groups or the like), aryl groups (e.g., substituted and unsubstituted aryl groups or the like), and the like and/or R₂ and R₃ are independently chosen from alkyl groups (e.g., substituted and unsubstituted alkyl groups or the like), aryl groups (e.g., substituted and unsubstituted aryl groups or the like), and the like. In various examples, one or more or all of R₁ and R₂, R₁ and R₃, R₂ and R₃, or R₁, R₂, and R₃ form a ring or rings (e.g.,

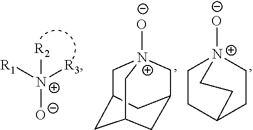

or the like, or a structural analog thereof). In various examples, R₁ comprises a cyclic group. In various examples, R₁ is

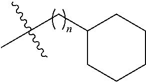

(e.g., where n is greater than 1 (e.g., 2, 3, 4, 5, 6, 7, 8, etc.),

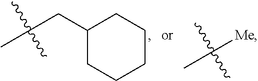

or the like. In various examples, R₁, R₂, or R₃ or any combination thereof independently comprise one or more functional group(s) (e.g., one or more alkyl and/or aryl group(s) or the like comprising one or more functional group(s)). In various examples, functional groups are hydrogen bond acceptors (e.g., groups comprising one or more N group(s), one or more O group(s), one or more structural analog(s) thereof, or the like, or any combination thereof). Non-limiting examples of functional groups include hydroxy groups, amine groups, ketones, esters, carboxylates, amides, structural analogs thereof, and the like, and any combination thereof. In various examples, a tertiary amine N-oxide comprises 2 or more carbons between a functional group and an N-oxide group. Without intending to be bound by any particular theory, it is considered one or more functional group(s) can stabilize tertiary amine N-oxide(s) and/or an absorption reaction. In various examples, one or more functional group(s) stabilize tertiary amine N-oxide(s) and/or an absorption reaction. In various examples, a tertiary N-oxide group comprises a group formed from one these tertiary N-oxides. In various examples, a tertiary amine N-oxide or a tertiary amine N-oxide group is (or comprises) the following structure:

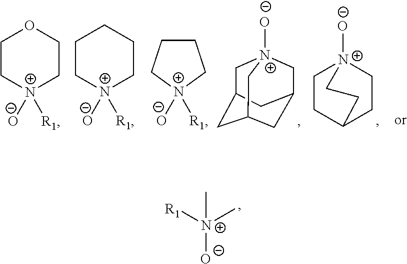

or the like, a structural analog thereof or a hydrate thereof, or a group formed therefrom. In various examples, R₁ is as defined above. In various examples, a tertiary N-oxide group comprises a group formed from one these tertiary N-oxides. In various examples, a tertiary amine N-oxide or a tertiary amine N-oxide group is (or comprises) the following structure:

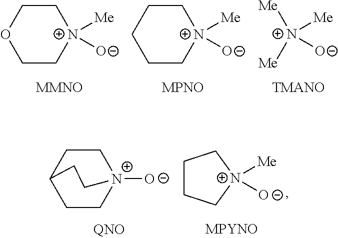

or the like, a structural analog thereof, or a hydrate thereof, or a group formed therefrom (MMNO is methyl morpholine N-oxide, TMANO is trimethyl amine N-oxide, QNO is quinuclidine N-oxide, and MPYNO is methyl pyrrolidine N-oxide).

In various examples, one or more or all of the tertiary amine N-oxide(s) and/or tertiary amine N-oxide group(S) is/are formed prior to or during contact with a carbon-source or sources. In various examples, one or more tertiary amine N-oxide(s) and/or one or more tertiary amine N-oxide group(s) is/are formed in situ. In various examples, one or more tertiary amine N-oxide(s) and/or one or more tertiary amine N-oxide group(s) is/are formed from one or more precursor(s) (e.g., tertiary amine precursor(s), tertiary amine precursor group(s), or any combination thereof). In various examples, one or more tertiary amine N-oxide(s) and/or one or more tertiary amine N-oxide group(s) is/are formed by oxidation (e.g., by one or more oxidizing agent(s)) of one or more precursor(s). In various examples, tertiary amine precursor(s) and/or tertiary amine precursor group(s) is/are independently chosen from tertiary alkyl amines, tertiary alkyl amine groups, or the like. Non-limiting examples of tertiary alkyl amines and tertiary alkyl amine groups include N-methyl morpholine, N-methyl pyrrolidine, trimethyl amine, and structural analogs thereof, hydrates thereof, and the like, and groups formed therefrom. In various examples, a precursor or precursor group is any amine precursor or amine precursor group which is able to react (e.g., by oxidation or the like) to form a tertiary amine N-oxide or tertiary amine N-oxide group (e.g., a tertiary amine N-oxide or tertiary amine N-oxide group of the present disclosure). In various examples, an oxidizing agent is chosen from peroxyacids and peroxides, and the like, and any combination thereof. Suitable oxidizing agents are known in the art. Non-limiting examples of oxidizing agents include meta-chloroperoxybenzoic acid, hydrogen peroxide, Caro's acid, HOF·CH₃CN and the like, and any combination thereof. In various examples, a tertiary amine N-oxide or oxides(s) and/or a tertiary amine N-oxide group or groups(s) is/are formed from one or more tertiary alkyl amine(s) and one or more oxidizing agent(s). In various examples, a method further comprises forming one or more tertiary amine N-oxide(s) and/or one or more tertiary amine N-oxide group(s) in situ.

In various examples, a capture sorbent is a solid capture sorbent. In various examples, a solid capture sorbent is a porous solid capture sorbent. In various examples, a solid capture sorbent comprises one or more tertiary amine N-oxide(s) and/or one or more tertiary amine N-oxide group(s) and/or one or more solid material(s) (such as, for example, polymeric materials and/or crystalline material(s). In various examples, one or more tertiary amine N-oxide(s) and/or one or more tertiary amine N-oxide group(s) is/are attached (such as, for example, attached by covalent bond, hydrogen bond, van der Waals interaction, adsorption, physisorption, chemisorption, graft, or the like, or any combination thereof) to at least a portion, substantially all, or all of one or more surface (e.g., an exterior surface or exterior surfaces thereof) of a solid sorbent material (such as, for example, a polymeric material, a crystalline material, or the like), In various examples, the one or more polymeric and/or amorphous and/or crystalline material(s) is/are porous. Non-limiting examples of solid materials include organic polymers, inorganic materials (such as, for example, silicon, silica, silicates, alumina, aluminosilicates, and the like), covalent-organic frameworks (COFs), metal-organic frameworks (MOFs), and the like, and any combination thereof. In various examples, a capture sorbent (such as, for example, a solid capture sorbent or the like) is a composition of the present disclosure).

In various examples, a method comprises contacting one or more carbon source(s) with water, optionally, one or more solvent(s) (e.g., co-solvent(s)), such as, for example, organic solvent(s) (e.g., polar aprotic solvent(s) or the like) or the like), and one or more capture sorbent(s) comprising one or more tertiary amine N-oxide(s) and/or one or more tertiary amine N-oxide group(s). Various amounts of water can be used. In various examples, the amount of water is about 0.5 equivalents to about 250 equivalents (relative to the equivalents of tertiary amine N-oxide(s) and/or tertiary amine N-oxide group(s)), including all 0.1 equivalent values and ranges therebetween. The pH of the water can vary. In various examples, the pH of the water is from about 6 to about 9, including all 0.1 pH values and ranges therebetween. In various examples, a solvent (e.g., a co-solvent), such as, for example, an organic solvent, which may be a polar aprotic solvent or the like, or the like) comprises one or more hydrogen-bond acceptor(s) (one or more or all of which may be strong hydrogen-bond acceptor(s)). Non-limiting examples of solvents include DMSO (which is a polar aprotic solvent comprising one or more strong hydrogen-bond acceptor(s)), N-methyl pyrrolidone (NMP) (which is a polar aprotic solvent comprising one or more strong hydrogen-bond acceptor(s)), acetonitrile (CH₃CN), methanol (MeOH), structural analogs thereof, and the like, and any combination thereof. In various examples, the amount of co-solvent(s) is about 0 M to about 2 M (relative to the amount of tertiary amine N-oxide(s) (e.g., the tertiary amine N-oxide concentration or the like), including all 0.1 M values and ranges therebetween (e.g., about 0.1 M to about 2M). In various examples, the amount of co-solvent(s) is about 0 percent by volume to about 100 percent by volume (relative to the total volume of the composition), including all 0.1 percent by volume values and ranges therebetween.

Contacting one or more carbon source(s) one or more capture sorbent(s) comprising one or more tertiary amine N-oxide(s) and/or one or more tertiary amine N-oxide group(s) and optionally, with water and optionally, one or more solvent(s), and may be repeated. In various examples, contacting is repeated a desired number of times (e.g., at least a second or more contacting). In various examples, at least a portion, substantially all, or all of the tertiary amine N-oxide(s) and/or one or more tertiary amine N-oxide group(s), optionally, water and/or solvent(s), if present, is/are used in each of the repeated contacting(s) (e.g., the second or more contacting(s)). In various examples, after one or more or all of the contacting(s), a method further comprises carrying out desorbing or resorbing (e.g., as described herein). In various examples, desorbing or reforming is repeated a desired number of times.

A method (such as, for example, the contacting(s) or the like) can be carried out at various temperatures. In various examples, a method is (e.g., the contacting(s) or the like are) carried out at a temperature of about 0 to about 100° C., including all 0.1° C. values and ranges therebetween (e.g., about 0 to about 80° C.). In various examples, a method is (e.g., the contacting(s) or the like are) carried out at room temperature (e.g., ambient temperature, such as, for example, about 20 to about 25° C. or about 20 to about 30° C.). In various examples, the contacting's of a method are carried out at about the same temperature or at two or more different temperatures.

In various examples, a reaction (e.g., an absorption reaction) between water and carbon dioxide, a structural analog thereof, or the like is reversible. In various examples, a method further comprises a reverse reaction (which may be referred to as desorption or a desorption reaction). In various examples, a desorption reaction (e.g., of carbonic acid (H₂CO₃), bicarbonate (HCO₃⁻), and/or a mixture thereof) forms (or re-forms) carbon dioxide. In various examples, a desorption reaction is carried out after an absorption reaction or reactions (e.g., an absorption reaction or reactions as described herein). In various examples, a desorption reaction results in formation or re-formation of, and optionally, recovery of (e.g., by forming or re-forming) at least a portion of, substantially all of, or all of the carbon dioxide reacted (e.g., consumed, separated or the like) in a previous absorption reaction(s). In various examples, a reaction (e.g., an absorption reaction or the like) between water and carbon dioxide is reversed by a change in gas composition (e.g., a reduction in CO₂ content or the like), a change in temperature, a change in pressure, or the like, or any combination thereof. In various examples, a method further comprising desorbing or re-forming at least a portion of, substantially all of, or all of the separated, captured, sequestered, or stored carbon dioxide.

In various examples, desorbing further comprises contacting the separated, captured, sequestered, or stored carbon dioxide or structural analog(s) thereof (e.g., carbonic acid (H₂CO₃), bicarbonate (HCO₃⁻), and/or a mixture thereof), or the like, or a combination thereof with a gas (e.g., an inert gas, such as, for example, a gas comprising N₂ gas, He gas, Ne gas, Ar gas, or the like, or any combination thereof) (e.g., a gas stream, bubbled gas, sparged gas, or the like), such that a partial pressure of CO₂ may be less than about 15% and/or reducing the pressure of the gas comprising carbon dioxide or subjecting the mixture of the gas comprising carbon dioxide, the water, and the capture sorbent(s) comprising one or more tertiary amine N-oxide(s) to reduced pressure (e.g., vacuum or the like).

In various examples, an absorption reaction occurs (e.g., a method, such as, for example, a method of any of the preceding claims, comprises) where a partial pressure of CO₂ is about 5 to about 100% at ambient pressure, including all 0.1% values and ranges therebetween (e.g., such as, for example, about 15 to about 100%). In various examples, a desorption reaction occurs (e.g., a method, such as, for example, a method according to claim 7, comprises) where a partial pressure of CO₂ is less than about 5% at ambient pressure, including all 0.1% values and ranges therebetween (e.g., such as, for example, less than 15%). In various examples, a method is carried out under vacuum. In various examples, a method is carried out at a pressure of about 2 to about 14 psi, including all 0.1 values and ranges therebetween. In various examples, a method is carried out between about 15 and about 150 psi, including all 0.1 psi values and ranges therebetween.

In an aspect, the present disclosure provides compositions. In various examples, a composition is a capture sorbent. In various examples, a composition comprises one or more tertiary amine N-oxide(s) (or group(s) formed therefrom). In various examples, a composition is configured to function and/or is suitable for use as a capture sorbent. Non-limiting examples of compositions are disclosed herein.

In various examples, a composition (e.g., a capture sorbent composition or the like) comprises one or more tertiary amine N-oxide(s) and/or one or more one or more tertiary amine N-oxide group(s). Non-limiting examples of tertiary amine N-oxides and tertiary amine N-oxide groups are provided herein.

A composition can comprise various tertiary amine N-oxides and/or tertiary amine N-oxide groups. In various examples, all of the tertiary amine N-oxides and/or tertiary amine N-oxide groups are the same. In various examples, at least two or more of the tertiary amine N-oxides and/or tertiary amine N-oxide groups are different (e.g., structurally different or the like).

A composition can comprise various amounts of tertiary amine N-oxides. In various examples, a composition, which may comprise water and/or solvent(s), comprises 0.001 M to 5 M tertiary amine N-oxides (based on the total volume of the composition), including all 0.1 percent by weight values and ranges therebetween (e.g., about 0.001 M to 2.5 M).

A composition may comprise water. In various examples, a composition further comprises water. In various examples, a composition is an aqueous solution (e.g., at least a portion, substantially all, or all of the one or more tertiary amine N-oxide(s) is/are dissolved).

A composition may comprise various amounts of water. In various examples, water is present in a composition at about 50 to about 25,000 molar percent (molar %) (based on total moles of the tertiary amine N-oxide(s) and/or tertiary amine N-oxide group(s)), including all 0.1 molar % values and ranges therebetween. In various examples, the amount of water is about 0.5 equivalents to about 250 equivalents (relative to the equivalents of tertiary amine N-oxide(s) and/or tertiary amine N-oxide group(s), including all 0.1 equivalent values and ranges therebetween. The pH of a composition (e.g., the water or the like) can vary. In various examples, the pH of the composition (e.g., the water or the like) is from about 6 to about 9, including all 0.1 pH values and ranges therebetween.

In various examples, a composition further comprises water and one or more solvent(s) (such as, for example, organic solvent(s), one or more or all of which may be a polar aprotic solvent or solvents. Non-limiting examples of solvents are described herein.

In various examples, a composition (such as, for example, a solid sorbent composition, a solid capture sorbent, or the like) comprises (or is) a solid composition (e.g., comprises a solid sorbent material). In various examples, a composition (such as, for example, a solid sorbent composition, a solid capture sorbent, or the like) comprises (or is) a polymeric material (such as, for example, a polymer or polymers or the like), an amorphous material, a crystalline material, or the like, or any combination thereof. In various examples, a composition (such as, for example, a porous solid sorbent composition, a porous capture sorbent, or the like) comprises (or is) a porous solid sorbent material. In various examples, a solid sorbent composition (which may be a porous solid sorbent composition) comprises one or more solid sorbent material(s) (such as, for example, one or more polymeric material(s) and/or one or more amorphous material(s) and/or one or more crystalline material(s), where one or more or all of the solid sorbent material(s) may be porous solid sorbent material(s)), and one or more tertiary amine N-oxide(s) and/or one or more tertiary amine N-oxide group(s). In various examples, the one or more polymeric and/or amorphous and/or crystalline material(s) is/are porous. Non-limiting examples of solid sorbent materials (which may be porous solid sorbent materials) include polymeric materials (such as, for example, organic polymers and the like), inorganic materials (such as, for example, silicon, silica, silicates, alumina, aluminosilicates, and the like, and any combination thereof), covalent-organic frameworks (COFs), hybrid materials (such as, for example, metal-organic frameworks (MOFs), and the like), and the like, and any combination thereof.

In various examples, one or more tertiary amine N-oxide(s) and/or one or more tertiary amine N-oxide group(s) is/are attached (such as, for example, attached by covalent bond, hydrogen bond, van der Waals interaction, adsorption, physisorption, chemisorption, graft, or the like, or any combination thereof) to at least a portion, substantially all, or all of one or more surface (e.g., an exterior surface or exterior surfaces thereof) of a solid sorbent material (such as, for example, a polymeric material, an amorphous material, a crystalline material, or the like), which may be a porous solid sorbent material (e.g., a porous polymeric material, a porous amorphous material, a porous crystalline material, or the like). In various examples, a solid sorbent material (such as, for example, a polymeric material, which may be a porous polymeric material, an amorphous material, which may be a porous amorphous material, or a crystalline material, which may be a porous crystalline material, or the like comprises (e.g., is partially, substantially, or fully impregnated with) one or more tertiary amine N-oxide(s) and/or one or more tertiary amine N-oxide group(s), which may be attached to (such as, for example, attached by covalent bond, hydrogen bond, van der Waals interaction, adsorption, physisorption, chemisorption, graft, or the like, or any combination thereof) the polymeric material, which may be a porous polymeric material, the amorphous material, which may be a porous amorphous material, or the crystalline material, which may be a porous crystalline material, or the like.

In various examples, a polymeric material, which may be a porous polymeric material, comprises a plurality of tertiary amine N-oxides and/or a plurality of tertiary N-oxide groups attached (e.g., by covalent bond, hydrogen bond, van der Waals interaction, adsorption, physisorption, chemisorption, graft, or the like, or any combination thereof). In various examples, a polymer backbone of a polymeric material comprises the tertiary amine N-oxides and/or the tertiary N-oxide groups and/or the tertiary amine N-oxides and/or the tertiary N-oxide groups are attached to a terminus or termini of a polymer, a backbone of the polymer, or any combination thereof. Non-limiting examples of polymeric materials include:

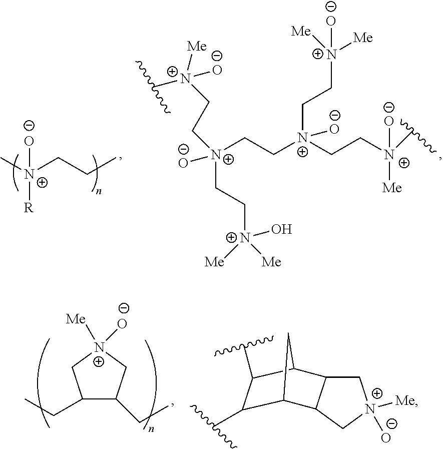

structural analogs thereof, copolymers thereof, hydrates thereof, and the like.

In various examples, a crystalline material, which may be a porous crystalline material comprises a plurality of tertiary amine N-oxides and/or a plurality of tertiary N-oxide groups attached (such as, for example, attached by covalent bond, hydrogen bond, van der Waals interaction, adsorption, physisorption, chemisorption, graft, or the like, or any combination thereof) thereto. In various examples, the tertiary amine N-oxides and/or the tertiary N-oxide groups are attached to at least a portion, substantially all, or all of one or more or all surface(s) (e.g., exterior surface(s), pore surface(s), or any combination thereof) of a crystalline material. Non-limiting examples of crystalline materials, which may be porous crystalline materials) include inorganic materials, such as, for example, silicon, silica, alumina, and the like, and any combination thereof. Non-limiting examples of crystalline materials, which may be porous crystalline materials, include porous inorganic crystalline materials (such as, for example, silica frameworks, aluminosilicate frameworks (e.g., porous silica, porous zeolites, and the like), covalent-organic frameworks (COFs), and metal-organic frameworks (MOFs), and the like, and any combination thereof. Non-limiting examples of inorganic materials (which may be amorphous or crystalline and/or nanoparticulate) include mesoporous silica materials, silicate materials, and aluminosilicate materials, which may comprise a hierarchical structure (e.g., Mobil Composition of Matter No. 41 (MCM-41), Santa Barbara Amorphous-15 (SBA-15), Zeolite Socony Mobil-5 (framework type MFI) (ZSM-5), and the like).

In various examples, a metal organic framework comprises one or more metal ion(s) and one or more organic linker(s). In various examples, a metal organic framework is amorphous or crystalline. Non-limiting examples of metal ions include Zr ion, Mg ion, Co ion (e.g., Co²⁺, Co³⁺, or the like), Ni ion, Zn ion, Mn ion, Al ion, Fe ion (e.g., Fe²⁺, Fe³⁺, or the like), Hf ion, and the like, and any combination thereof. Non-limiting examples of organic linkers include:

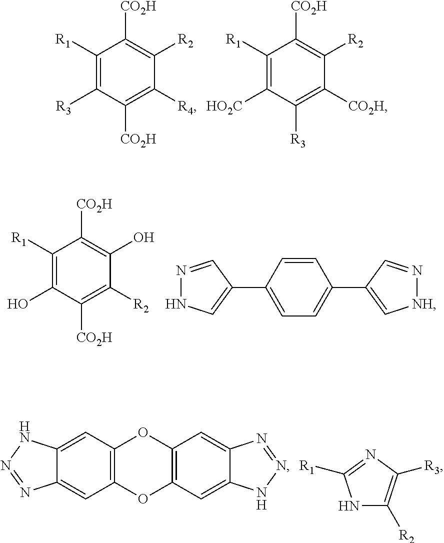

structural analogs thereof, and the like, and any combination thereof. In various examples, R₁, R₂, R₃, and R₄, if present, are independently chosen from —H, alkyl groups (e.g., substituted and unsubstituted alkyl groups or the like), aryl groups (e.g., substituted and unsubstituted aryl groups or the like), and the like. In various examples, one or more a metal organic framework(s) independently comprises one or more of these metal ions and/or one or more of these organic linkers. Non-limiting examples of metal organic frameworks (which may be amorphous or crystalline and/or nanoparticulate) include zirconium-based metal-organic frameworks (MOFs) (e.g., MOF(s) comprising hexanuclear zirconium oxide groups and 1,4-benzenedicarboxylate (bdc) linkers) (such as, for example, UIO-66, UIO-67, structural analogs thereof, and the like), MOF-74 (e.g., MOFs comprising metal(II) oxide groups (e.g., chains or the like) and 2,5-dioxido-1,4-benzenedicarboxylate linkers) (such as, for example, MOF-74-Mg, MOF-74-Co, MOF-74-Ni, MOF-74-Zn, structural analogs thereof, and the like), Zn₅Cl₄(btdd)₃ (btdd=bis(1H-1,2,3-triazolo[4,5-b],[4′,5′-i])dibenzodioxin), Cu₂Cl₂btdd, Ni₂Cl₂btdd, Co₂Cl₂btdd, Mn₂Cl₂btdd, trimesate-based metal-organic frameworks (such as, for example, MIL-96-Al, MOF-808, structural analogs thereof, and the like), Zn(bdp) (bdp=(1,4-benzenedipyrazolate), zeolitic imidazolate framework-8 (such as, for example, ZIF-8, structural analogs thereof, and the like), structural analogs thereof, and the like, and any combination thereof.

A polymeric material, an amorphous material, or a crystalline material can have various surface area. In various examples, a polymeric material, an amorphous material, or a crystalline material comprises a surface area of about 0 m²/g to about 10,000 m²/g, including all 0.0005 m²/g values and ranges therebetween and/or 0.001 percent to about 50 percent by weight (based on the total weight of the porous polymeric material and/or the porous crystalline material), including all 0.1 percent by weight values and ranges therebetween, of the tertiary amine N-oxide group(s). Surface area can be determined by methods known in the art. In various examples, surface area is determined by absorption isotherm analysis (e.g., BET pore size and/or surface area analysis or the like), or the like.

A polymeric material, which may be a porous polymeric material, an amorphous material, which may be a porous amorphous material, or a crystalline material, which may be a porous polymeric material, or any combination thereof can comprise various amounts of tertiary amine N-oxide groups. In various examples, a polymeric material (or a porous polymeric material), an amorphous material (or a porous amorphous material), a crystalline material (or porous crystalline material), or a combination thereof comprises 0.001 percent by weight to about 50 percent by weight tertiary amine N-oxide groups (based on the total weight of the polymeric material, the porous polymeric material, the amorphous material, the porous amorphous material, the crystalline material, the porous crystalline material, or the combination thereof), including all 0.1 percent by weight values and ranges therebetween (e.g., about 0.1 to about 50 percent by weight). In various examples, a polymeric material, an amorphous material, a crystalline material, or a combination thereof comprises a surface area of about 0 m²/g to about 10,000 m²/g, including all 0.0005 m²/g values and ranges therebetween.

A porous polymeric material, a porous amorphous material, or a porous crystalline material can have various porosity. In various examples, a porous polymeric material, a porous amorphous material, or a porous crystalline material comprises a pore size range of about 1 nm (nm=nanometer(s)) to about 50 nm, including all 0.1 nm values and ranges therebetween, and/or (ii) a surface area of about 0.001 m²/g to about 10,000 m²/g, including all 0.0005 m²/g values and ranges therebetween, and/or (iii) 0.001 percent to about 50 percent by weight (based on the total weight of the porous polymeric material and/or the porous crystalline material), including all 0.1 percent by weight values and ranges therebetween, of the tertiary amine N-oxide group(s). Pores size dimension can be determined by methods known in the art. In various examples, pore size and/or surface area is/are determined by absorption isotherm analysis (e.g., BET surface area analysis or the like), or the like.

A composition can exhibit desirable stability. In various examples, a composition is resistant to decomposition from heat and/or oxidation. In various examples, a composition does not decompose (e.g., exhibits no observable decomposition) or exhibits about 5% or less decomposition after about 0 days to about 1 week, including all hour values and ranges therebetween, at about 95 to about 100° C., including all 0.1° C. values and ranges therebetween. In various examples, a composition does not decompose (e.g., exhibits no observable decomposition) or exhibits about 5% or less decomposition after about 0 days to about 1 week, including all hour values and ranges therebetween in contact with ambient air (e.g., oxygen in ambient air). In various examples, a composition does not decompose (e.g., exhibits no observable decomposition) or exhibits about 5% or less decomposition after about 0 days to about 1 week, including all hour values and ranges therebetween, at about 95 to about 100° C., including all 0.1° C. values and ranges therebetween (e.g., oxygen in ambient air). Decomposition can be observed by methods known in the art. For example, decomposition is observed by NMR or the like.

In an aspect, the present disclosure provides systems for separating, capturing, sequestering, storing, or the like, or any combination thereof, a carbon source or sources (such as, for example, carbon dioxide, a structural analog or analogs thereof, or the like, or any combination thereof), or any combination thereof. In various examples, a system comprises one or more composition(s) (such as, for example, one or more capture sorbent(s)) of the present disclosure and/or is configured to carry out a method or methods of carbon capture (such as, for example, a method or methods of the present disclosure). Non-limiting examples of systems are disclosed herein.

A system can comprise various compositions of the present disclosure. In various examples, at least two or more or all of the compositions (e.g., capture sorbent(s)) are different (e.g., structurally different, compositionally different, or both). In various examples, one or more or all of the composition(s) (e.g., a capture sorbent or capture sorbents) is/are a solid comprising a solid sorbent material or materials as described herein. In various examples, one or more or all of the composition(s) (e.g., a capture sorbent or capture sorbents) (such as, for example, a solid sorbent composition or solid sorbent compositions) independently comprises (or is) a solid composition (e.g., comprises a solid sorbent material or materials). In various examples, one or more or all of the composition(s) (e.g., a capture sorbent or capture sorbents) (such as, for example, a porous solid sorbent composition or porous solid sorbent compositions) independently comprises (or is) a porous solid sorbent material or materials. In various examples, a solid sorbent composition (which may be a porous solid sorbent composition) comprises one or more solid sorbent material(s) (such as, for example, one or more polymeric material(s) and/or crystalline material(s), where one or more or all of the solid sorbent material(s) may be porous solid sorbent material(s)), and one or more tertiary amine N-oxide(s) and/or one or more tertiary amine N-oxide group(s). In various examples, the one or more polymeric and/or crystalline material(s) is/are porous.

In various examples, a system comprises or is a CO₂ scrubbing unit or the like. In various examples, one or more composition(s) (e.g., the CO₂ scrubbing unit) is/are in fluid and/or gas connection to one or more emission stream(s) comprising CO₂ (e.g., waste emission, industrial emission, product emission, or the like, or any combination thereof). In various examples, an emission stream comprises an undesirable amount of carbon dioxide. In various examples, a system (e.g., a CO₂ scrubber) comprising one or more composition(s) in fluid and/or gas connection to one or more emission stream(s), comprising an undesirable amount of carbon dioxide (e.g., waste emission, industrial emission, product emission, or the like, or any combination thereof) is configured to remove at least a portion of the carbon dioxide from the emission stream(s).

A system can comprise various operational configurations. In various examples, a system is configured to operate in a continuous flow mode, a semi-continuous flow mode, or a batch mode, or the like, or any combination thereof.

The following Statements provide examples of methods, compositions, and systems of the present disclosure:

Statement 1. A method of separating, capturing, sequestering, or storing, or the like, or any combination thereof, carbon dioxide (CO₂) (e.g., carbon dioxide gas), one or more structural analog(s) thereof, or the like, or a combination thereof comprising: contacting a gas comprising the CO₂, the structural analog(s) thereof, or the combination thereof or a liquid comprising the CO₂, the structural analog(s) thereof, or the combination thereof (e.g., a gas atmosphere or a gas stream comprising carbon dioxide or the like or a liquid comprising carbon dioxide, structural analog or the like) (e.g., a liquid comprising dissolved carbon dioxide or the like), or the like with water or the like and one or more capture sorbent(s) of the present disclosure (e.g., one or more capture sorbent(s) of any one of Statements 15 to 28) (e.g., one or more capture sorbent(s) independently comprising one or more tertiary amine N-oxide(s) and/or one or more group(s) independently formed from a tertiary amine N-oxide (one or more tertiary amine N-oxide group(s)), where at least a portion, substantially all, or all of the CO₂ (e.g., carbon dioxide gas), the one or more structural analog(s) thereof, or the like, or the combination thereof is separated, captured, sequestered, or stored, or the like, or any combination thereof.

Statement 2. A method according to Statement 1, where the tertiary amine N-oxide(s) and/or the tertiary amine N-oxide group(s) independently comprise the following structure:

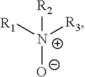

a structural analog thereof or a hydrate thereof, or a group formed therefrom or the like, where R₁ is chosen from —H, substituted and unsubstituted alkyl groups, and substituted and unsubstituted aryl groups and the like; R₂ and R₃ are independently chosen from substituted and unsubstituted alkyl groups, and substituted and unsubstituted aryl groups and the like; and/or one or more of R₁ and R₂, R₁ and R₃, R₂ and R₃, or R₁, R₂, and R₃ form a ring or rings or the like (e.g.,

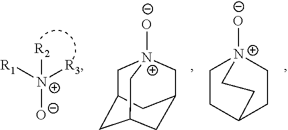

or a structural analog thereof, or the like).

Statement 3. A method according to Statement 1 or 2, where the tertiary amine N-oxide(s) and/or the tertiary amine N-oxide group(s) independently comprise the following structure:

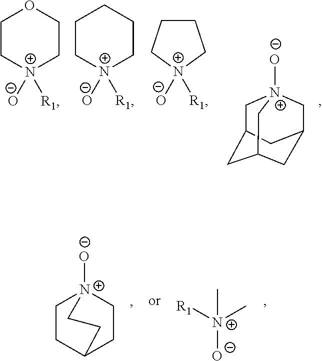

a structural analog thereof or a hydrate thereof, or a group formed therefrom or the like.

Statement 4. A method according to any one of the preceding Statements, where R₁ is

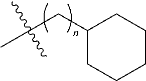

(e.g., where n is greater than 1, such as, for example, 1, 2, 3, 4, 5, 6, 7, or 8), or

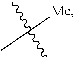

or a structural analog thereof, or the like.

Statement 5. A method according to any one of the preceding Statements, where one or more or all of the capture sorbent(s) comprises the tertiary amine N-oxide group(s) attached to at least a portion, substantially all, or all of one or more solid material(s), such as, for example, polymeric material(s) and/or one or more amorphous(s) material(s) one or more crystalline material(s), or the like).

Statement 6. A method according to any one of the preceding Statements, where the tertiary amine N-oxide(s) and/or tertiary amine N-oxide group(s) is/are formed prior to or during the contacting and/or the tertiary amine N-oxide(s) and/or tertiary amine N-oxide group(s) is/are formed from one or more tertiary alkyl amine(s) and/or one or more tertiary alkyl amine group(s) and one or more oxidizing agent(s).

Statement 7. A method according to any one of the preceding Statements, further comprising desorbing or re-forming, or the like, at least a portion of, substantially all, or all of the separated, the captured, the sequestered, or the stored CO₂, stored the structural analog(s) thereof, or the combination thereof.

Statement 8. A method according to Statement 7, where the desorbing or the like further comprises contacting the separated, the captured, the sequestered, or the stored, or the like, carbon dioxide (e.g., carbonic acid (H₂CO₃), bicarbonate (HCO₃⁻), and/or a mixture thereof), or the combination thereof with a gas (e.g., an inert gas, such as, for example, a gas comprising N₂ gas, He gas, Ne gas, Ar gas, or the like, or any combination thereof) (e.g., a gas stream, bubbled gas, sparged gas, or the like) or the like, such that a partial pressure of CO₂ or the like is less than about 15% and/or reducing the pressure of the gas comprising carbon dioxide or subjecting a mixture of the gas comprising carbon dioxide or the like, the water or the like, and the capture sorbent(s) comprising the one or more tertiary amine N-oxide(s) and/or the one or more tertiary amine N-oxide group(s) to reduced pressure (e.g., vacuum or the like) or the like.

Statement 9. A method according to any one of the preceding Statements, where the method is carried out at a temperature of about 0 to about 100° C., including all 0.1° C. values and ranges therebetween (e.g., about 0 to about 80° C.), or about room temperature (e.g., about 20 to about 25° C. or about 20 to about 30° C., including all 0.1° C. values and ranges therebetween).

Statement 10. A method according to any one of the preceding Statements, where the pH (e.g., of the water and/or one or more or all of the one or more capture sorbent(s)) is from about 6 to about 9, including all 0.1 values and ranges therebetween.

Statement 11. A method according to any one of the preceding Statements, where the contacting comprises contacting the gas comprising the CO₂, the structural analog(s) thereof, or the combination thereof or a liquid comprising the CO₂ (e.g., dissolved carbon dioxide or the like, the structural analog(s) thereof, or the combination thereof with the water and one or more co-solvent(s) (such as, for example, one or more solvent(s) (e.g., organic solvent(s), such as, for example, polar aprotic solvent(s) or the like)).

Statement 12. A method according to Statement 11, where the one or more co-solvents (e.g., solvent(s), such as, for example, organic solvent(s)) is/are chosen from DMSO, N-methyl pyrrolidone (NMP), acetonitrile (CH₃CN), methanol (MeOH), structural analogs thereof, and the like, and any combination thereof.

Statement 13. A method according to any one of the preceding Statements, where the gas comprising the CO₂ (e.g., a gas atmosphere, a gas stream, or a liquid comprising dissolved carbon dioxide gas, or the like, or any combination thereof), the structural analog(s) thereof, or the combination thereof is a waste gas, an industrial gas (e.g., an industrial waste gas, an industrial product gas, or the like, or any combination thereof), or any combination thereof or the liquid comprising the CO₂, the structural analog(s) thereof, or the combination thereof is a waste stream, an industrial stream (e.g., an industrial waste stream, an industrial product stream, or the like, or any combination thereof), or any combination thereof.

Statement 14. A method according to any one of the preceding Statements, further comprising repeating the contacting a desired number of times (e.g., at least a second or more contacting), where at least a portion, substantially all, or all of the tertiary amine N-oxide(s) and/or the tertiary amine N-oxide group(s), optionally, water, and/or optionally, one or more organic solvent(s) is/are used in each of the repeating the contacting(s) (e.g., the second or more contacting(s)) and, optionally, after one or more or all of the repeated contacting(s), carrying out desorbing or resorbing (e.g., as described in Statements 7 and 8).

Statement 15. A composition (also referred to herein as a capture sorbent composition) (e.g., configured for use in a method of the present disclosure, such as, for example, a method of any one of Statements 1 to 14, and/or a system of the present disclosure, such as, for example, a system of any Statements 27 to 38), comprising one or more tertiary amine N-oxide(s) and/or one or more tertiary amine N-oxide group(s).

Statement 16. A composition (or capture sorbent composition) according to Statement 15, where the tertiary amine N-oxide(s) and/or the tertiary amine N-oxide group(s) independently comprise the following structure:

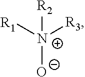

a structural analog thereof or a hydrate thereof, or a group formed therefrom or the like, where R₁ is chosen from —H, substituted and unsubstituted alkyl groups, substituted and unsubstituted aryl groups, and the like; R₂ and R₃ are independently chosen from substituted and unsubstituted alkyl groups, substituted and unsubstituted aryl groups, and the like; and, optionally, one or more of R₁ and R₂, R₁ and R₃, R₂ and R₃, or R₁, R₂, and R₃ form a ring or rings or the like (e.g.,

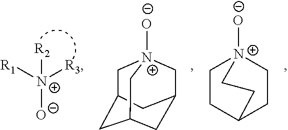

or a structural analog thereof, or the like).

Statement 17. A composition (or capture sorbent composition) according to Statement 15 or 16, where the one or more tertiary amine N-oxide(s) and/or the one or more tertiary amine N-oxide group(s) independently comprise the following structure:

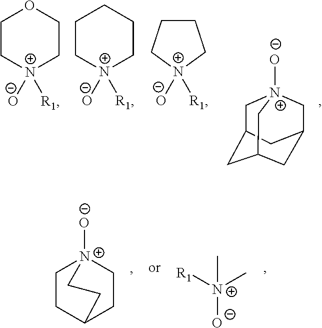

a structural analog thereof or a hydrate thereof, or a group formed therefrom or the like.

Statement 18. A composition (or capture sorbent composition) according to any one of Statements 15 to 17, where R₁ is

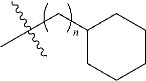

(e.g., where n is greater than 1, such as, for example, 1, 2, 3, 4, 5, 6, 7, or 8), or

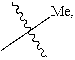

or a structural analog thereof, or the like.

Statement 19. A composition (or capture sorbent composition) according to any one of Statements 15 to 17, where at least a portion, substantially all, or all of the tertiary amine N-oxide group(s) is/are attached to at least a portion, substantially all, or all of one or more surface(s) of one or more solid material(s) (e.g., solid material(s) independently chosen from polymeric materials, amorphous materials, crystalline materials, and any combination thereof) (e.g., polymeric material(s) and/or one or more amorphous material(s) and/or one or more crystalline material(s) and/or the like and/or any combination thereof).

Statement 20. A composition (or capture sorbent composition) according to Statement 19, where at the one or more crystalline material(s) are independently chosen from silica frameworks, aluminosilicate frameworks (such as, for example, zeolites and the like), covalent organic frameworks, metal organic frameworks, and the like.

Statement 21. A composition (or capture sorbent composition) according to Statements 19 or 20, where the one or more solid material(s) (e.g., one or more polymeric material(s) and/or one or more amorphous material(s) and/or one or more crystalline material(s) and/or the like and/or any combination thereof) independently comprise 0.001 percent by weight to about 50 percent by weight (based on the total weight of the porous polymeric material and/or the porous crystalline material), including all 0.1 percent by weight values and ranges therebetween, of the tertiary amine N-oxide group(s).

Statement 22. A composition (or capture sorbent composition) according to any one of Statements 19 to 21, where at least a portion, substantially all, or all of or one or more of the one or more solid material(s) (e.g., one or more polymeric material(s) and/or one or more amorphous material(s) and/or one or more crystalline material(s) and/or the like and/or any combination thereof) is/are one or more polymeric material(s) and/or one or more crystalline material(s) is/are porous solid material(s) (e.g., solid material(s) independently chosen from polymeric materials, amorphous materials, crystalline materials, and any combination thereof).

Statement 23. A composition (or capture sorbent composition) according to Statement 22, where the porous solid material(s) (e.g., the one or more porous polymeric material(s) and/or the one or more porous amorphous material(s) and/or the one or more porous crystalline material(s) and/or the like and/or the combination thereof) independently comprise (i) a pore sire range of about 1 nm (nm=nanometer(s)) to about 50 nm, including all 0.1 nm values and ranges therebetween, and/or (ii) a surface area of about 0.001 m²/g to about 10,000 m²/g, including all 0.0005 m²/g values and ranges therebetween, and/or (iii) 0.001 percent to about 50 percent by weight (based on the total weight of the one or more porous polymeric material(s) and/or the one or more porous crystalline material(s)), including all 0.1 percent by weight values and ranges therebetween, of the tertiary amine N-oxide group(s).

Statement 24. A composition (or capture sorbent composition) according to any one of Statements 15 to 23, further comprising water or the like (e.g., the composition is an aqueous solution, such as, for example, where at least a portion, substantially all, or all of the one or more tertiary amine N-oxide(s) is/are dissolved).

Statement 25. A composition (or capture sorbent composition) according to Statement 24, where an amount of water is about 50 to about 25,000 molar percent (molar %) (based on total moles of the tertiary amine N-oxide(s) and/or tertiary amine N-oxide group(s)), including all 0.1 molar % values and ranges therebetween.

Statement 26. A composition (or capture sorbent composition) according to any one of Statements 15 to 25, where the composition further comprises one or more co-solvent(s) (e.g., at least a portion, substantially all, or all of the one or more tertiary amine N-oxide(s) is/are present (e.g., dissolved or the like) in water and/or one or more co-solvent(s) (e.g., solvent(s), such as, for example, organic solvent(s) and the like)).

Statement 27. A composition (or capture sorbent composition) according to Statement 26, where the one or more co-solvent(s) is/are chosen from DMSO, N-methyl pyrrolidone (NMP), acetonitrile (CH₃CN), methanol (MeOH), structural analogs thereof, and the like, and any combination thereof.

Statement 28. A composition (or capture sorbent composition) according to any one of Statements 15 to 27, where the composition is resistant to decomposition from heat and/or oxidation (e.g., the composition does not decompose (e.g., exhibits no observable decomposition) or exhibits about 5% or less decomposition after about 0 days to about 1 week, including all 0.1 day values and ranges therebetween, at about 95 to about 100° C., including all 0.1° C. values and ranges therebetween) (e.g., in contact with ambient air (e.g., oxygen in ambient air)).

Statement 29. A system (e.g., configured to carry out a method of the present disclosure, such as, for example, a method of any one of Statements 1 to 14) for separating, capturing, sequestering, storing, or any combination thereof, carbon dioxide, one or more structural analogs thereof, or the like, or a combination thereof, comprising one or more capture sorbent composition(s) of the present disclosure (such as, for example, of any one of Statements 15 to 28).

Statement 30. A system according to Statement 29, where the system is a CO₂ scrubbing unit or the like.

Statement 31. A system according to Statement 29 or 30, where the one or more composition(s) (e.g., the CO₂ scrubbing unit) is/are in fluid and/or gas connection to one or more emission stream(s) comprising the CO₂, the one or more structural analogs thereof, or the like, or the combination thereof (e.g., waste emission, industrial emission, product emission, or the like, or any combination thereof) or the like

Statement 32. A system according to any one of Statements 29 to 31, where the system is configured to operate in a continuous flow mode, a semi-continuous flow mode, a batch mode, or the like, or any combination thereof.

Statement 33. A system according to any one of Statements 29 to 32, where one or more, substantially all, or all of the one or more capture sorbent composition(s) comprise(s) the one or more tertiary amine N-oxide group(s) attached (e.g., chemically attached (e.g., by covalent bond, hydrogen bond, van der Waals interaction, graft, or the like, or any combination thereof), adsorbed, physisorbed, chemisorbed, grafted to or the like) to at least a portion, substantially all, or all of one or more or all surface(s) of solid material(s) (e.g., one or more polymeric material(s) and/or one or more amorphous material(s) and/or one or more crystalline material(s) and/or the like and/or any combination thereof) or the like.

The steps of the methods described in the various examples disclosed herein are sufficient to carry out the methods of the present disclosure. Thus, in various examples, a method consists essentially of a combination of the steps of the methods disclosed herein. In various other examples, a method consists of such steps.

The following examples are presented to illustrate the present disclosure. They are not intended to be limiting in any manner.

### Example 1

This example provides a description of methods, compositions, and systems of the present disclosure.

Harnessing Oxidized Amines as Robust Sorbents for Carbon Capture. Carbon capture and sequestration (CCS) is important to mitigate global climate change, but current implementation falls far short of that needed to reach net-zero global emissions by 2050. Aqueous amine solutions, conceived over a century ago, are the current leading technology for CO₂ separations. However, amines suffer from chemical instability under scrubbing conditions, corrosiveness, and toxicity, hindering their long-term implementation at multi-ton scales. Herein, it was demonstrated for the first time that tertiary amine N-oxides, an oxidative degradation product of amines, can remove CO₂ from dilute streams, including flue gas from a natural gas-fired power plant. Our extensive spectroscopic and computational studies support that the non-toxic, non-corrosive, and inexpensive 4-methylmorpholine N-oxide (MMNO) captures CO₂ under humid conditions via the formation of a hydrogen-bond-stabilized bicarbonate (HCO₃⁻) species, despite being significantly less basic than an amine. Accelerated aging studies show that MMNO exhibits superior oxidative and thermal stability compared to structurally similar amines, highlighting the potential of eco-friendly N-oxides in industrial carbon capture applications.

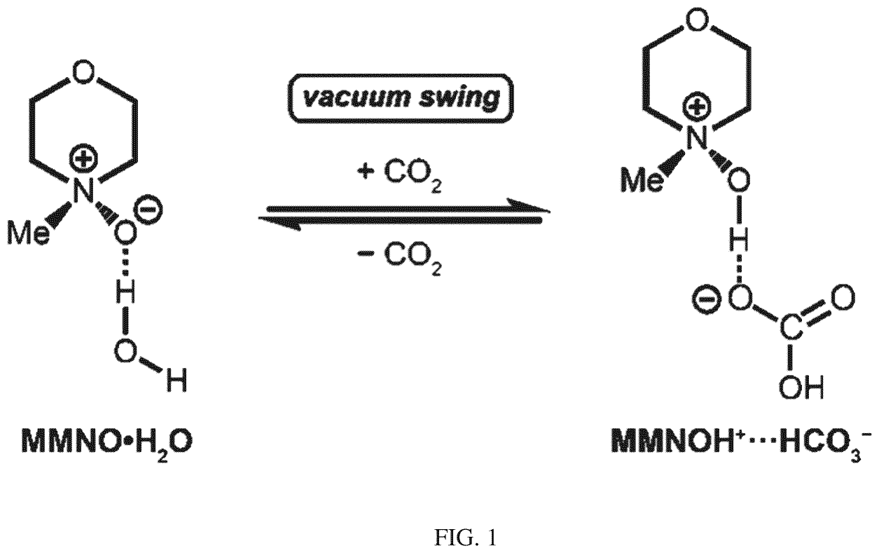

In this example, it was demonstrated that oxidation of trialkylamines to the corresponding trialkylamine N-oxides does not preclude their use for carbon capture, as weakly basic MMNO is capable of binding CO₂ under humid conditions via the formation of a hydrogen-bond-stabilized HCO₃⁻ species (FIG. 1). In addition, MMNO exhibits good oxidative and thermal stability under testing conditions, is minimally volatile, and releases CO₂ at room temperature in a simulated vacuum swing process and ˜65° C. in a simulated temperature swing process.

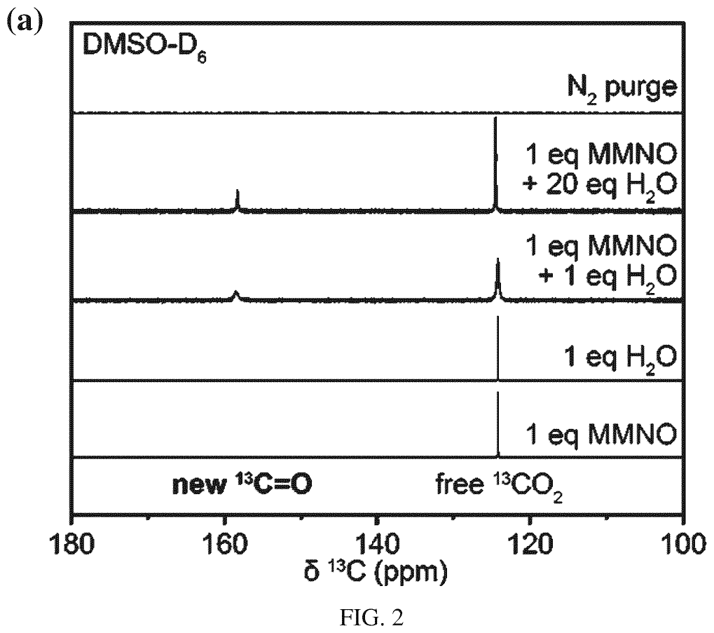

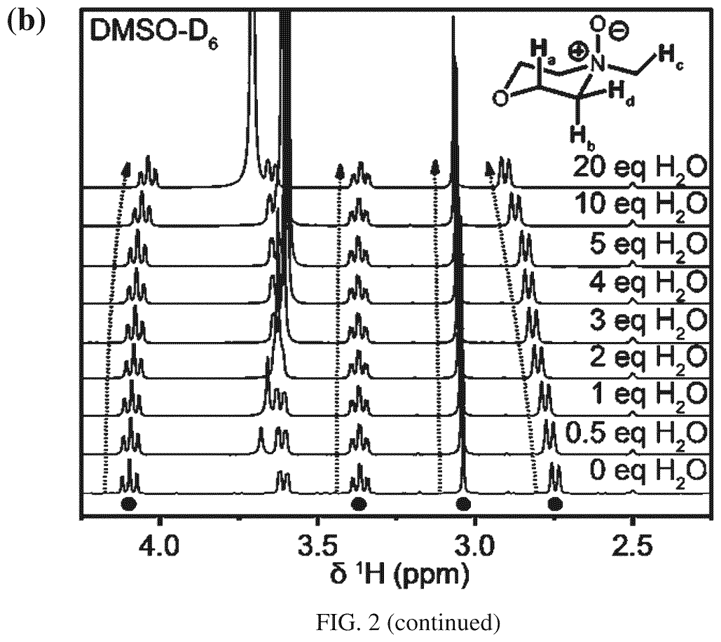

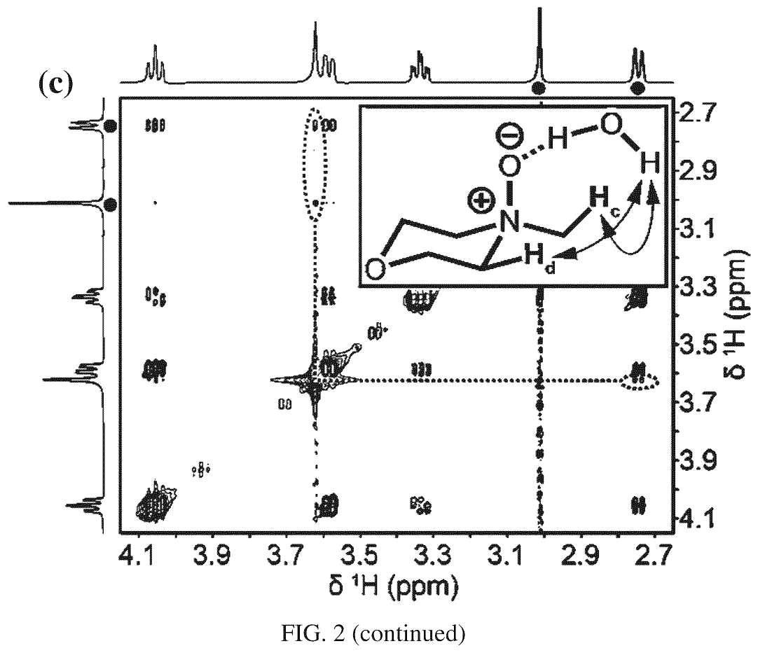

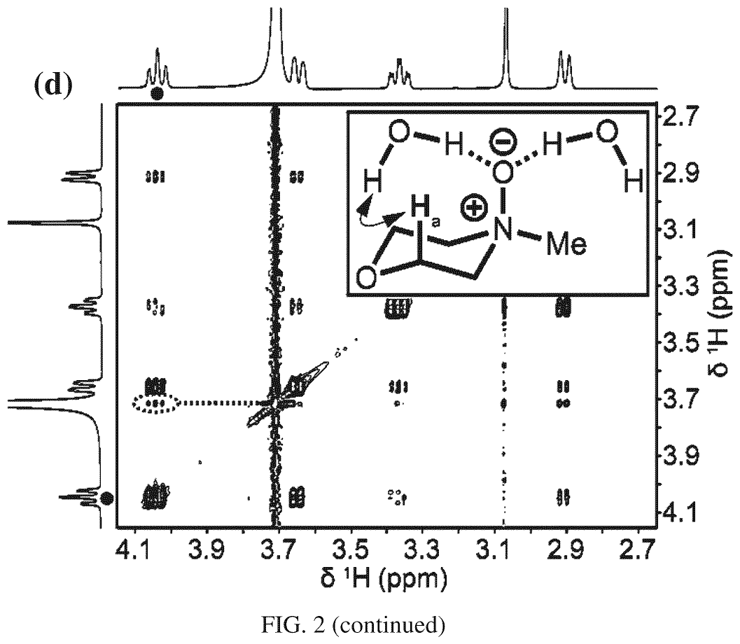

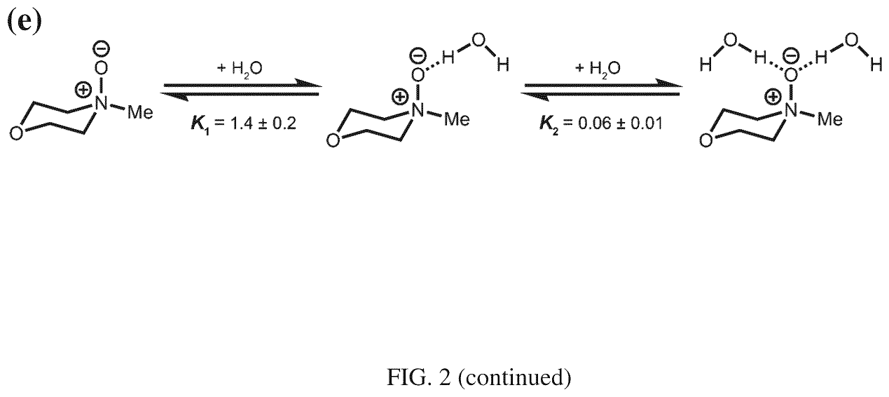

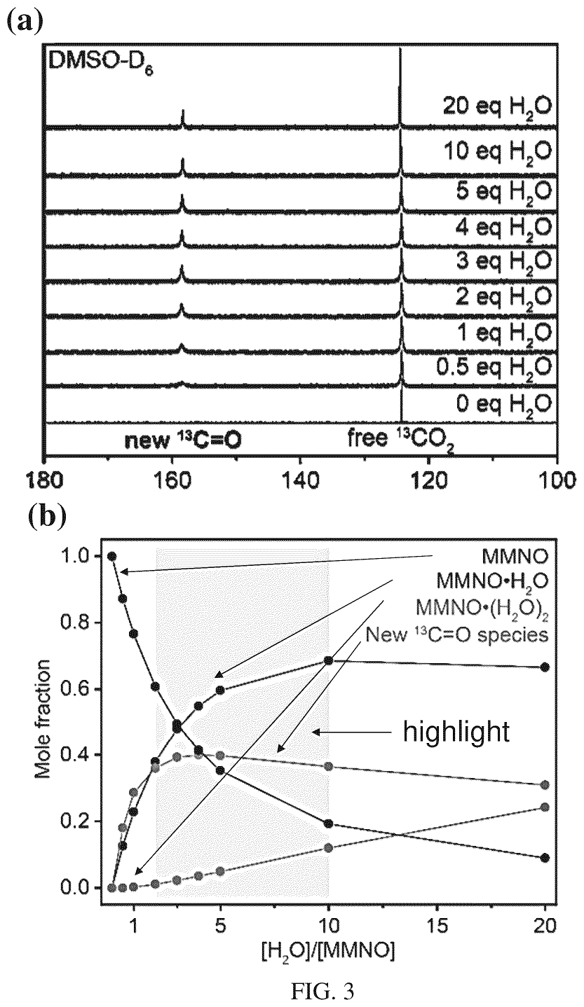

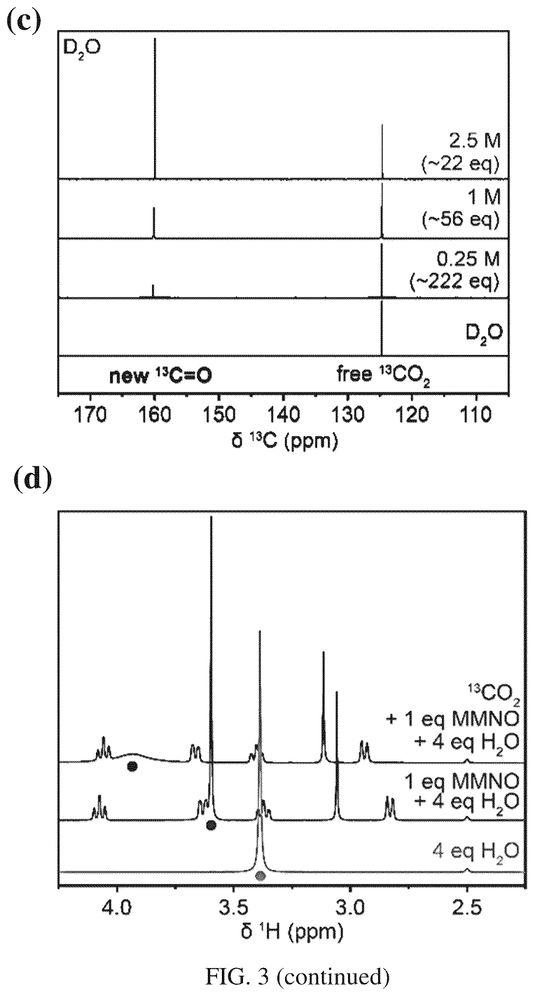

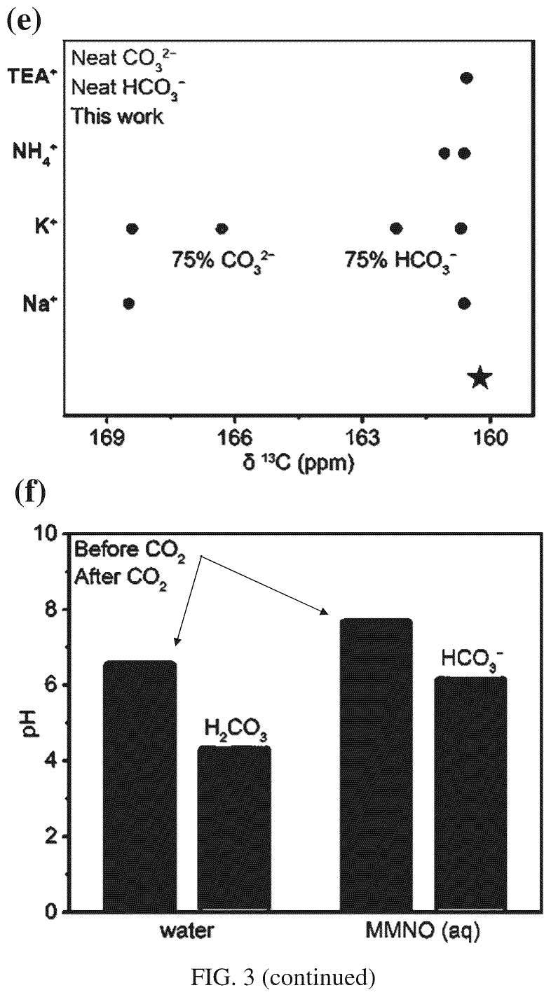

Role of water in CO₂ capture with MMNO. To probe whether MMNO is capable of reversibly binding CO₂, ¹³C nuclear magnetic resonance (NMR) experiments in wet deuterated dimethyl sulfoxide (DMSO-D6) were conducted at 25° C. The presence of MMNO induced significant broadening of the resonance corresponding to dissolved CO₂ (124-125 ppm); in addition, a new broad resonance (158-159 ppm) corresponding to a carbonyl (C═O)-containing species was observed. The broad nature of the observed resonances indicates that free CO₂ and the new species are undergoing slow-intermediate exchange on the ¹³C NMR time scale (kex<|Δν|). As such, experiments were conducted with ¹³CO₂ in anhydrous DMSO-D₆ to better visualize the chemically bound ¹³CO₂ adduct and to carefully control the equivalents of H₂O present in the solution (FIG. 2(a)). With water or anhydrous MMNO alone, no new species form upon dosing the solution with ¹³CO₂. However, when an equimolar solution of H₂O and MMNO is dosed with ¹³CO₂, a broad new resonance appears at 158-159 ppm, which is assigned to a ¹³CO₂ adduct of MMNO and H₂O (MMNO·H₂O·¹³CO₂) containing a C═O group (the same is observed for up to 20 equivalents of H₂O, see FIGS. 2(a) and 3(a)). The free ¹³CO₂ resonance is also significantly broadened due to chemical exchange interactions (FIG. 2(a)). Notably, bubbling N₂ through the solution for 60 minutes at room temperature (simulating a vacuum swing) leads to full desorption of chemically bound ¹³CO₂, supporting that the reaction between MMNO, H₂O, and ¹³CO₂ can be readily reversed (FIG. 2(a)). Furthermore, CO₂ could also be released at −65° C. in a simulated temperature swing process conducted through variable-temperature (VT) NMR studies, reflecting the lower regeneration temperature of MMNO compared to amines. Notably, no degradation or rearrangement of MMNO occurred under these conditions (including being heated to 125° C. under CO₂ followed by desorption), as confirmed by ¹H-¹³C 2D HMBC spectroscopy.

The presence of H₂O is important for MMNO to react with CO₂. Unlike amines, N-oxides are not strongly nucleophilic nor Brønsted basic (pKa of R₃N+—OH=4.5-5), yet they are highly Lewis basic and one of the strongest neutral organic hydrogen-bond acceptors due to the polar N→O bond (dipole moment˜5 D) and the formal negative charge on O. To better understand the role of H₂O in the CO₂ capture process, MMNO hydrate (MMNO·(H₂O)n) formation was first probed using the interaction-induced chemical shift perturbations of MMNO as the host and H₂O as the guest molecule in DMSO-D₆. NMR titration experiments were performed with three different MMNO concentrations (0.125 M, 0.25 M, and 0.5 M) with increasing equivalents of water. At all three host concentrations, the ¹H chemical shifts were perturbed as H₂O was titrated (FIG. 2(b)), consistent with fast-exchange interactions between MMNO and its hydrates on the ¹H NMR time scale (kₑₓ>>|Δν|). Among the nuclei monitored, Hₐ and H_{d} of MMNO experience the largest perturbations (FIG. 2(b)), indicating that they participate in the interaction with H₂O most closely. The NMR titration experimental data were fit to five binding models corresponding to host:guest ratios of 1:1 (monohydrate) or 1:2 (dihydrate) using Bindfit with a global non-linear regression method (see-Table 3 for model features). The 1:2 full model yielded the best cov_{fit} (see Table 3 for details), indicating that the binding of the second H₂O molecule is made weaker by the binding of the first, with an interaction parameter (a) of 0.2. Together, these NMR studies support the association of H₂O with MMNO to form both MMNO·H₂O and MMNO·(H₂O)₂, with the maximum relative molar ratio of MMNO·H₂O reached at 5-10 equivalents of H₂O added relative to MMNO (FIG. 3(b)).

Intermolecular 2D nuclear Overhauser effect spectroscopy (NOESY) experiments were conducted to further probe the nature of the interactions between H₂O and MMNO (FIGS. 2(c) and 2(d)). With 1 equivalent of H₂O in 0.25 M MMNO in DMSO-D₆ at a long mixing time of 600 ms, the NOESY H_{c} (3.0 ppm) and α (to N)-equatorial H_{d} (2.7 ppm) protons of MMNO (FIG. 2(c)). This spectrum provides direct evidence for the preferred H₂O binding site (A) for MMNO·H₂O, in which H₂O hydrogen bonds to the oxygen of MMNO in an orientation pointing away from the ring. In contrast, with 20 equivalents of H₂O, an additional intense cross-peak becomes visible. The new peak represents an interaction between the H₂O proton (3.7 ppm) and β (to N)-axial Hₐ (4.0 ppm), revealing the second binding pocket (B) for water to hydrogen bond with MMNO in an orientation pointing towards the ring in MMNO·(H₂O)₂ (FIG. 2(d)). Combining the NMR titration and NOESY experiments, the mechanism of MMNO hydrate and dihydrate formation can be recapitulated (FIG. 2(e)).

Mechanism of CO₂ capture with MMNO·H₂O. To interrogate the formation of MMNO·H₂O·¹³CO₂, NMR titration experiments with MMNO (0.25 M in DMSO-D₆) in the presence of ¹³CO₂ were conducted (FIG. 3(a)). By integrating the resonances corresponding to dissolved ¹³CO₂ and MMNO·H₂O·¹³CO₂, the relative mole fractions of both species as a function of H₂O equivalents added could be determined (FIG. 3(b)). The mole fraction of MMNO·H₂O·¹³CO₂ relative to dissolved ¹³CO₂ maximizes at 2-10 equivalents of H₂O added relative to MMNO, which is a similar MMNO:H₂O ratio at which the concentration of MMNO·H₂O maximizes in the absence of CO₂ (highlighted in FIG. 3(b)). This finding indicates that MMNO·H₂O is likely responsible for CO₂ capture under these conditions. Likewise, dosing ¹³CO₂ into solutions of MMNO in D₂O (spanning from ˜22 to ˜222 equivalents of D₂O) yields a new resonance (˜160 ppm) corresponding to a MMNO·¹³CO₂ adduct, which was not observed in D₂O alone (FIG. 3(c)). Furthermore, the relative integrations of free ¹³CO₂ and this adduct showed a negative correlation between the concentration of MMNO·¹³CO₂ and the D₂O:MMNO ratio.

Although observing MMNO·H₂O·¹³CO₂ directly by ¹H NMR is challenging due to the dynamic fast-exchange nature of ¹³CO₂ binding on the ¹H NMR time scale, the chemical shift observed for H₂O further supports the formation of a ¹³CO₂ adduct. For example, at 4 equivalents of H₂O relative to MMNO in DMSO-D₆, the exchange among free H₂O, H₂O·MMNO, and MMNO·(H₂O)₂ results in a shift downfield from 3.4 ppm to 3.6 ppm due to strong hydrogen-bonding interactions between H₂O and MMNO (FIG. 3(d)). Markedly, in the presence of ¹³CO₂, the resonance of H₂O shifts to 3.9 ppm and further broadens (FIG. 3(d)), which likely results from exchanging with a new species possessing a much more downfield-shifted proton (i.e., MMNO·H₂O·¹³CO₂) on top of the exchange pathways discussed above.

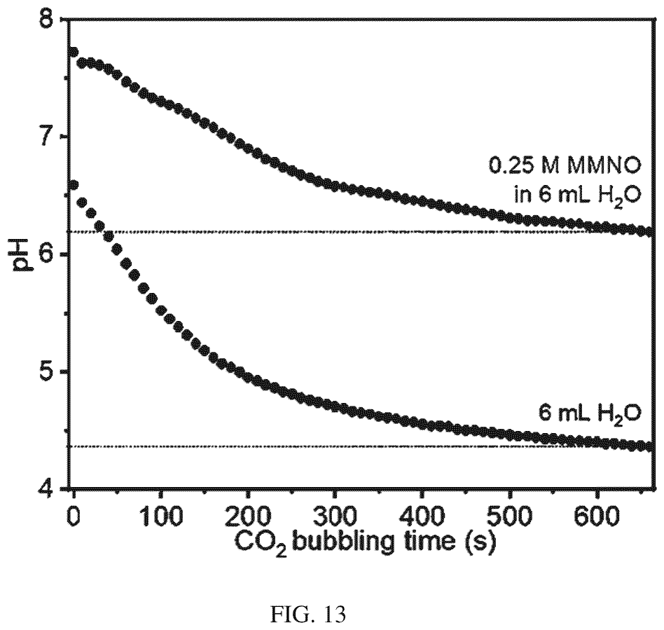

Based on the observations above, the most likely mechanistic scenario is that MMNO·H₂O—and not free MMNO—reacts with CO₂ via carbonic acid (H₂CO₃, pKₐ₍ₐₚₚₐᵣₑₙₜ₎˜6),^{42,43} HCO₃⁻ (pKₐ˜10),⁴² or CO₃²⁻ formation. The latter is unfavored because, unlike amines, MMNO is not basic enough to deprotonate HCO₃⁻ to form CO₃²⁻. An alternative mechanistic pathway in which the oxygen of the N-oxide directly attacks CO₂ was ruled out based on ¹⁵N and ¹H-¹³C 2D HMBC spectroscopies and density functional theory (DFT) calculations. To distinguish among these possibilities, ¹³C NMR experiments were conducted to benchmark the chemical shift of the CO₂ adduct formed with MMNO·H₂O in D₂O against various HCO₃⁻ and CO₃²⁻ salts (FIG. 3(e)). The experimental ¹³CNMR chemical shift of MMNO·¹³CO₂ in D₂O (160 ppm) is closer to that observed for HCO₃⁻ (160.6-160.7 ppm) than for CO₃²⁻ (161.1-168.5 ppm) or that predicted for H₂CO₃ (152 ppm). Furthermore, the pH was monitored when CO₂ was bubbled through a 0.25 M aqueous MMNO solution and ultrapure water for comparison (FIGS. 3(f) and 13). In pure water, the pH drops and then stabilizes at 4.36, at which only dissolved CO₂ and H₂CO₃ are present. However, in the presence of MMNO, a steady state at pH 6.19 was observed, corresponding to the apparent pK₁ of 6.35 at which no CO₃²⁻ is present in aqueous solutions. Together, these findings support that carbon capture with MMNO·H₂O occurs via the formation of a HCO₃⁻ species stabilized by hydrogen bonding with MMNO.

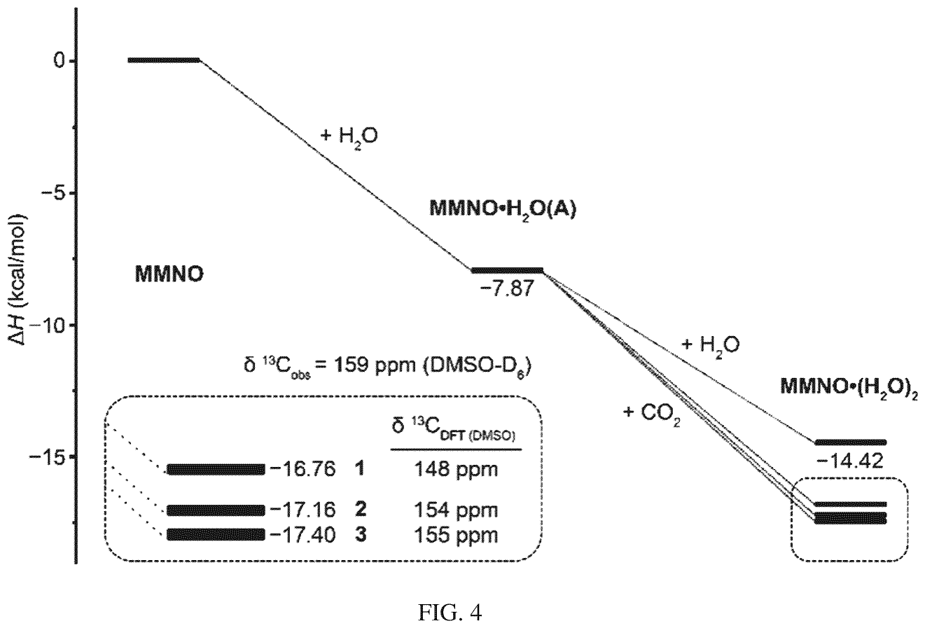

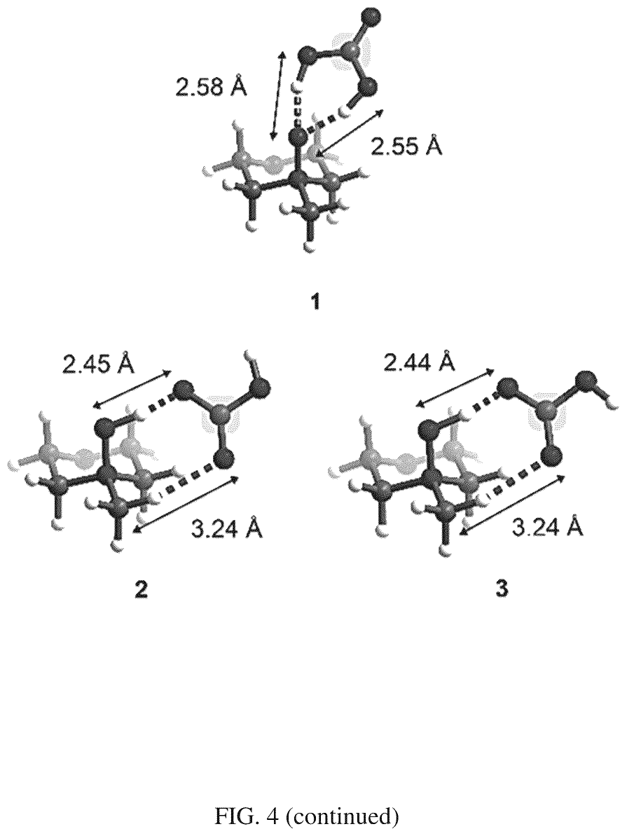

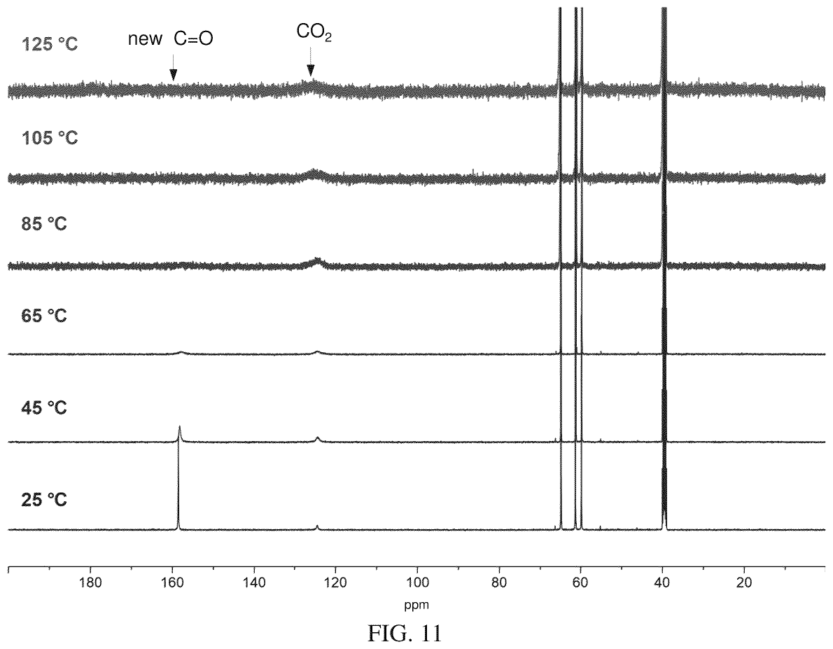

DFT calculations were next performed with Gaussian 16 at the ωB97XD level of theory at 298.15 K in DMSO as the solvent to support the proposed pathway (FIG. 4). Optimized structures of MMNO·H₂O (A) and MMNO·(H₂O)₂ were found to have H₂O bound in preferred orientations that match well with the NOESY experiments (FIGS. 4, 2(c), and 2 (d)). Three possible and energetically similar adducts (1-3) based on different conformations of MMNO-H⁺···HCO₃⁻ or MMNO···H₂CO₃ can be envisioned (FIG. 4). For structures 2 and 3, the O···O distances (2.45 Å for 2, 2.44 Å for 3) for the most important hydrogen bond interactions (O—H⁺···O⁻) are much shorter than in 1 (2.55 Å and 2.58 Å), within the range of strong hydrogen-bonding interactions (2.2-2.5 Å). Further, C—H···O interactions are also predicted in optimized structures 2 and 3. The ¹³C chemical shifts corresponding to the C═O carbons in 1-3 were also predicted using the gauge-independent atomic orbitals method at the same level of theory in DMSO. The calculated chemical shift (155 ppm) of 3 agrees best with the experimental chemical shift (159 ppm) of MMNO·H₂O·¹³CO₂ in DMSO-D₆, making 3 the most plausible structure for this adduct. However, due to the highly dynamic nature of this reaction, the involvement of other species cannot be ruled out. Further, our calculations also support that MMNO·H₂O reacting with CO₂ is favored by ΔΔH=2.34-2.98 kcal/mol compared to MMNO·(H₂O)₂ formation, supporting that CO₂ capture is still favored even in the presence of excess H₂O. The calculated CO₂ binding enthalpy for 3 relative to MMNO·H₂O is only −9.53 kcal/mol, which is significantly less downhill than that normally observed for amines (less than −12 kcal/mol). This finding explains why MMNO·H₂O·CO₂ can release CO₂ easily (˜65° C. under pure CO₂ atmosphere, (FIG. 11), whereas most amines must be heated above 100° C. to be regenerated in a temperature swing process.

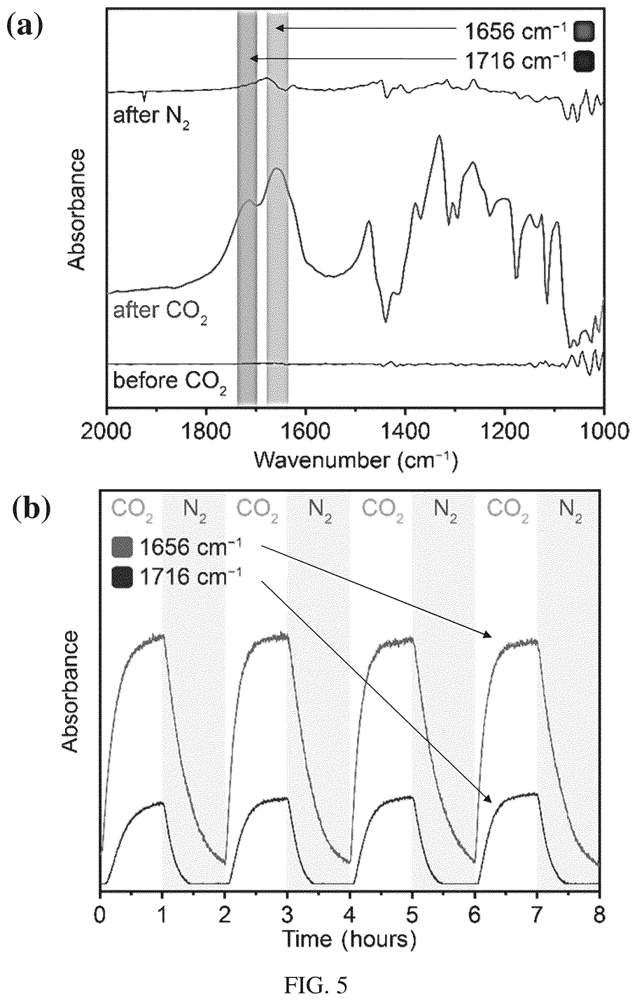

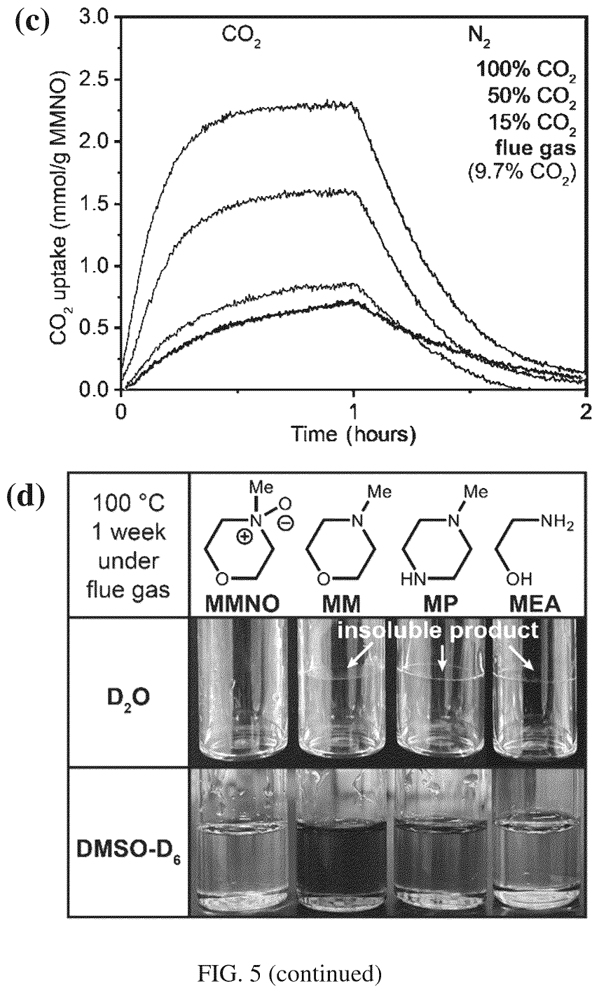

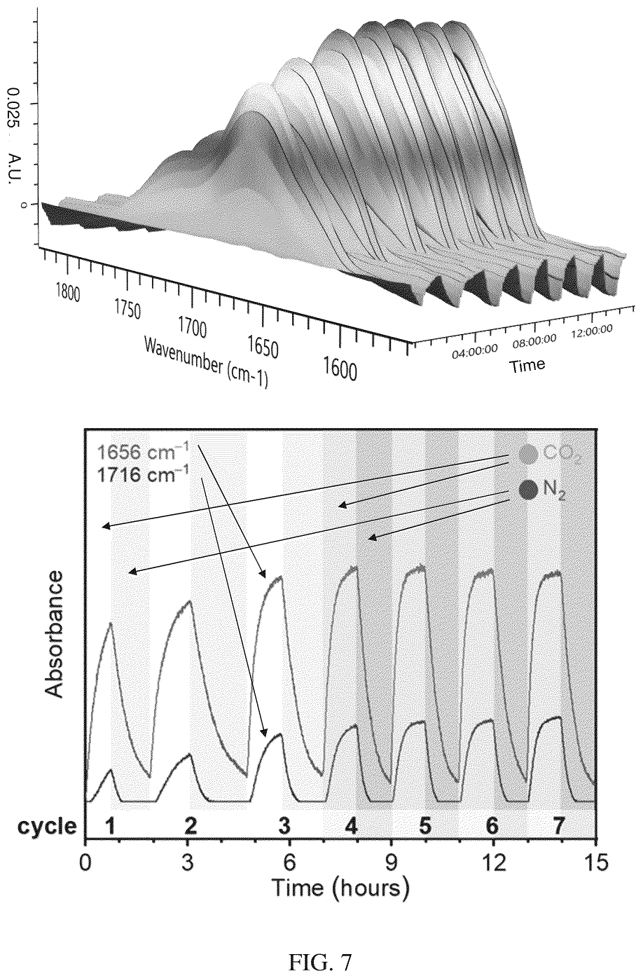

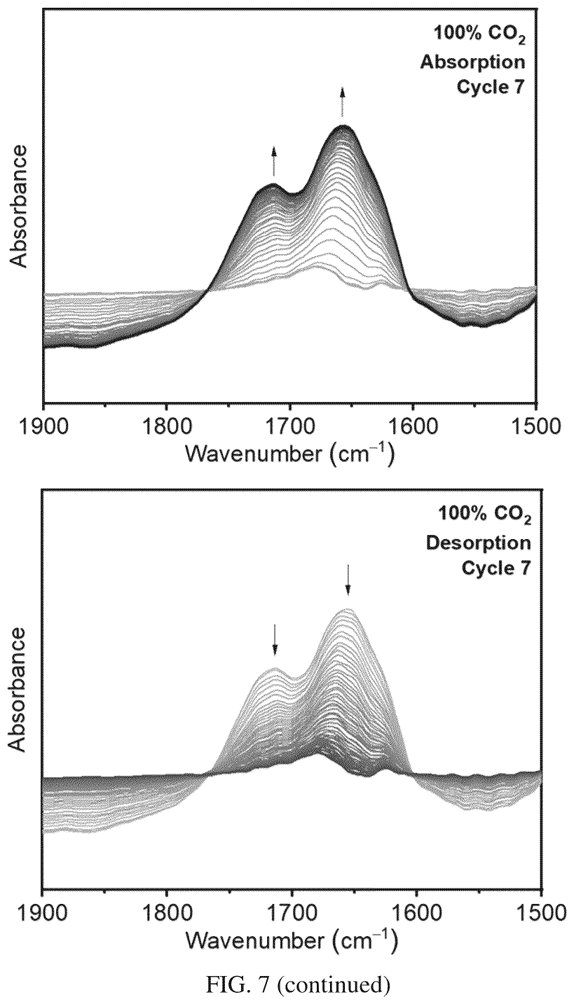

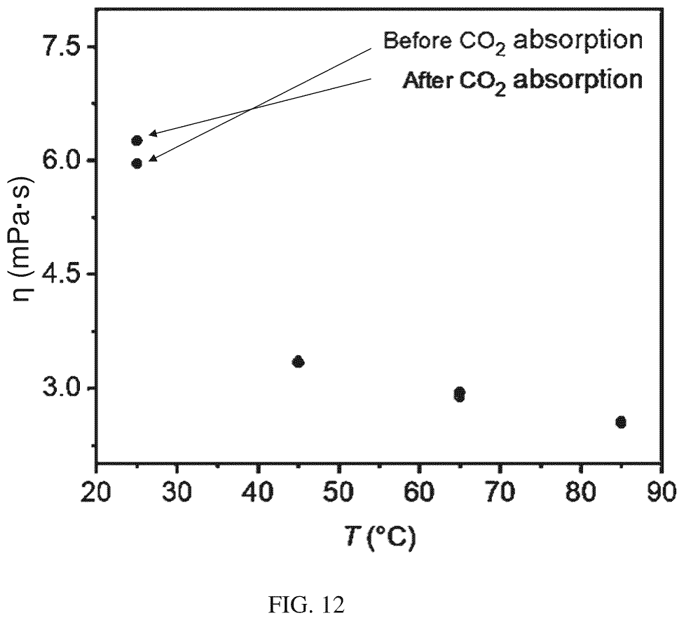

Carbon capture cyclability, performance, and stability. The studies outlined above support that MMNO·H₂O can reversibly react with CO₂ to form MMNO—H⁺···HCO₃ (3), representing a new pathway for CO₂ absorption. To validate that this mechanism enables carbon capture under realistic conditions, the cyclability of CO₂ binding was evaluated using infrared (IR) spectroscopy. Owing to its reasonable saturation time and ease of preparation, a 1:4 (v:v) mixture of commercially available 50 wt. % (˜6.5 equivalents of water) aqueous MMNO solution and DMSO was employed for these measurements (both components were used directly as received). Upon bubbling CO₂ (6 sccm), two new characteristic C═O stretches at 1656 cm¹ and 1716 cm⁻¹ were found to increase in intensity over time (FIG. 5(a)), which can be attributed to the formation of MMNO—H⁺···HCO₃⁻ Indeed, DFT-calculated vibrational frequencies of proposed products 2 and 3 reveal a similar two-peak profile in the range of 1550-1800 cm⁻¹. Upon purging the solution with N₂, these signals disappear, consistent with the reversibility of CO₂ binding observed by ¹³C NMR (FIG. 2(a)). Emulating a vacuum-swing process, pure CO₂ was bubbled through the MMNO solution (6 sccm) for 1 hour, followed by pure N₂ (6 sccm) for 1 hour. Good reversibility was observed over seven cycles, with the last four cycles showing nearly identical profiles ((FIG. 5(b)), see (FIG. 7)) for the first three cycles before stabilizing). Absorption and desorption were largely completed in less than 30 minutes; in addition, viscosity measurements revealed that this solution retained low viscosities both before and after CO₂ dosing (FIG. 12)). Gravimetric chemisorbed CO₂ capacities were also measured by weighing solutions before and after 1 hour of absorption, corrected by solvent controls under the same conditions (see Tables 2 and 3). It was determined that the MMNO solution reaches a capacity of 2.32 mmol chemisorbed CO₂/g MMNO under a pure CO₂ stream in 1 hour (FIG. 5(c)).

To evaluate whether MMNO·H₂O can remove CO₂ from dilute, mixed gas streams, 50% and 15% CO₂ mixtures in N₂ were flowed through the same MMNO solution (FIG. 5(c)). Good capacities (1.48 and 0.92 mmol chemisorbed CO₂/g MMNO, respectively) were still observed by IR and gravimetric measurements after 1 hour under these conditions. However, real flue gas streams contain contaminants other than N₂, including O₂, H₂O, NOₓ, and SOₓ, that can lead to sorbent degradation. A sample of flue gas from the Cornell Combined Heat and Power (CHP) natural gas-fired power plant—consisting of 9.7% CO₂, 3.8% O₂, 43 ppm NOₓ, remainder H₂O and N₂—was obtained to test the CO₂ capture capability of MMNO·H₂O from an industrial waste stream. Remarkably, it was determined that MMNO·H₂O can capture CO₂ from this flue gas to reach a capacity of 0.70 mmol chemisorbed CO₂/g MMNO after 1 hour at room temperature, with no additional stretches observed due to sorbent degradation by IR. Under industrial post-combustion carbon capture conditions, absorption is normally conducted at ˜40° C., which is estimated to lead to an approximately 20% reduction in CO₂ chemisorption capacity.

One of the significant limitations of amine-based scrubbers is their poor long-term cycling stability arising from oxidative and thermal degradation. Indeed, heating the amines 4-methyl morpholine (MM) and 1-methylpiperazine (MP), two close structural analogs of MMNO, and monoethanolamine (MEA), a benchmark amine for carbon capture, in D₂O for 1 week at 100° C. under flue gas led to the formation of insoluble impurities (FIG. 5(d)). More degradation was observed for MM, MP, and MEA in wet DMSO-D₆ after the same accelerated aging studies: the solutions became darkly colored, and numerous new species were observed by ¹H NMR. In contrast, MMNO exhibits excellent stability after being heated in both D₂O and wet DMSO-D₆ at 100° C. under flue gas (FIG. 5(d)). No degradation was observed in D₂O, and the only degradation product observed upon extended heating in DMSO-D₆ under flue gas was MM, likely due to slow 0 atom transfer from MMNO to the solvent. Notably, MM can be easily reoxidized to MMNO with hydrogen peroxide in the presence of CO₂ as the catalyst, offering a potential method for sorbent regeneration after extended cycling.

Given the immediacy of the looming climate crisis, new sorbents are needed that can be rapidly scaled and employed in engineering configurations that have already been optimized for amine-based scrubbers. The presented gas sorption, spectroscopic, and computational studies support that the monohydrates of tertiary amine N-oxides, an oxidation product of tertiary amines, can capture CO₂ via a new hydrogen-bonding pathway. The inexpensive MMNO is robust towards oxygen and high temperatures while exhibiting good CO₂ uptake from dilute streams, including flue gas from a natural gas-fired power plant. Although further experimental verification is needed, the DFT-calculated relatively low heat of absorption of this system could potentially offer opportunities for high-feed-pressure systems as well. Our findings lay the groundwork for the further development of small-molecule and polymeric tertiary amine N-oxides as non-basic sorbents for challenging CO₂ separations.

Supporting Information. General Procedures. Chemicals. All reagents were purchased from commercial vendors and used without additional purification unless specified otherwise. 4-Methylmorpholine N-oxide (MMNO) (solid, 97%, Ambeed) was either used directly without purification or purified 2-3 times via vacuum sublimation at 100° C. until it was visually white and was stored in a N₂-filled glovebox (only to keep anhydrous for the purpose of following analysis) when not in use. The negligible water content was verified by the absence of a detectable water signal by proton nuclear magnetic resonance (¹H NMR) spectroscopy before use. MMNO (45-55 wt. % in water, Sigma-Aldrich) was stored in a 6° C. fridge when not in use. Freshly prepared and commercial solutions of MMNO were tested with peroxide testing strips (Quantofix, peroxyde 100, 1-100 mg/L H₂O₂) to ensure insignificant levels of hydrogen peroxide (H₂O₂) (less than 1 mg/L) before use. MMNO is manufactured commercially using aqueous H₂O₂ solution. H₂O₂ can react in the presence of CO₂ and water to form peroxymonocarbonate (HCO₄⁻) species, for which the ¹³C NMR resonance is close to those of bicarbonate (HCO₃⁻) species. The lack of H₂O₂ was confirmed for the purpose of clearer spectroscopic assignments. N-oxides are not reported to be peroxide formers.

Deuterated dimethyl sulfoxide (DMSO-D₆) (99.9%, Cambridge Isotope Laboratories, Inc.) was dried over activated 3 Å molecular sieves for at least 24 hours and degassed by three freeze-pump-thaw cycles prior to storage in a N₂-filled glovebox over activated 3× molecular sieves. The negligible water content was confirmed with the absence of a detectable water signal in ¹H NMR spectra before use. Anhydrous DMSO was purchased from Sigma-Aldrich in Sure-Seal™ bottles, then stored in a N₂-filled glovebox over activated 3 Å molecular sieves. ¹³CO₂ (99 atom % ¹³C, less than 3 atom % 180) was purchased from Sigma-Aldrich. CO₂ (bone dry grade, 50% N₂ mixture, and 15% N₂ mixture) were purchased from Airgas. Flue gas samples were obtained from the Cornell Combined Heat and Power Plant on May 11, 2024, in 25 Liter Tedlar Bag with Roberts Style Valve (9.7% CO₂, 3.8% O₂, 43 ppm NOₓ, remainder H₂O and N₂). Sodium bicarbonate (NaHCO₃, 100%, Aldon), sodium carbonate (Na₂CO₃, 100%, Aldon), potassium bicarbonate (KHCO₃, 99%, Oakwood), potassium carbonate (K₂CO₃, 99%, Fluka), ammonium bicarbonate (NH₄HCO₃, greater than 99.5%, Fluka), ammonium carbonate ((NH₄)₂CO₃, greater than 99%, Acros), tetraethylammonium bicarbonate (TEAHCO₃, 95%, Sigma-Aldrich), pyridine N-oxide (95%, Sigma-Aldrich), 4-picoline N-oxide (98%, Sigma-Aldrich), 4-methylmorpholine (MM, 99%, Sigma-Aldrich), 1-methylpiperazine (MP, 99%, Sigma-Aldrich), monoethanolamine (MEA, ≥98%, Sigma-Aldrich), and hydrogen peroxide (H₂O₂, 30% in water, Thermo Scientific) were purchased from commercial vendors and used without additional purification. Ultrapure water used for pH measurements was obtained using a Millipore Synergy® 185 water purification system. All procedures were carried out on the benchtop unless specified otherwise.

Nuclear Magnetic Resonance (NMR). All NMR spectra were recorded at 298.15 K (25° C.) unless specified otherwise for variable temperature (VT) measurements. ¹H and (VT) ¹³C NMR were recorded on Bruker AVIII and AVIII HD (500 MHz), or Varian INOVA (500 MHz) spectrometers. ¹H-¹H Nuclear Overhauser effect spectroscopy (NOESY) and ¹H-¹³C heteronuclear multiple bond correlation spectroscopy (HMBC) were recorded on Varian INOVA (600 MHz) spectrometer. ¹H-¹⁵N HMBC was recorded on Bruker AVIII HD (500 MHz) spectrometer. All samples in DMSO-D₆ were equilibrated for 2 minutes before measurements, and all samples in D₂O were equilibrated for 5 min before measurements. Air-free NMR spectra were taken in Wilmad screw-cap NMR tubes (528-TR-7-V17M). All NMR spectra were analyzed using MestreNova (Mestrelab research S.L.). All chemical shifts are reported in parts per million (ppm) downfield from tetramethylsilane (TMS). Proton resonances are referenced to residual protium in the NMR solvent (2.50 ppm for DMSO-D₆, 4.79 ppm for D₂O). Carbon resonances are referenced to the carbon resonance of the NMR solvent (39.52 ppm for DMSO-D₆). When D₂O was used as the NMR solvent, carbon resonances were referenced to the carbon resonance of chloroform-D (CDCl₃, 77.16 ppm) in a flame-sealed capillary tube placed in the same NMR tube or by using the absolute referencing function in MestreNova (Mestrelab research S.L.) to reference to TMS.

Infrared Spectroscopy (IR). Infrared spectra were recorded with a ReactIR™ iC10 FTIR spectrometer (Mettler Toleda AutoChem, Inc.) fitted with a 30-bounce, silicon-tipped probe. Flue gas was dosed through a Model 22 syringe infusion pump (Harvard Apparatus).

Viscosity Measurement. Viscosities were measured on a Discovery Hybrid Rheometer HR-3 (TA Instruments) equipped with Peltier Concentric Cylinder system using a geometry of DIN conical rotor and standard cup.

pH Measurements. pH measurements were conducted with a HI 221 Calibration Check Microprocessor pH Meter (Hanna Instruments). A 3-point calibration (with pH 4, pH 7, and pH 10 buffers) was performed before the measurement.

Procedure for CO₂ and ¹³CO₂ Dosing. Sample Preparation Before Dosing. For regular dosing, commercially available MMNO was added directly along with commercially available DMSO-D₆. For dosing with controlled water amount, a screw-cap NMR tube was dried in a 165° C. oven for at least 12 hours and then brought into a N₂-filled glovebox. Dry, solid MMNO was weighed out and added to the NMR tube, followed by the addition of dry DMSO-D₆ via micropipette. The tube was then sealed with the screw cap and then brought out of the N₂-filled glovebox. Alternatively, D₂O (instead of DMSO-D₆) or deionized (DI) water was added quickly via syringe into a screw-cap NMR tube charged with dry MMNO outside of a N₂-filled glovebox.

CO₂ Dosing. The bone-dry grade CO₂ cylinder was connected to a Schlenk line through a 3-way valve, which was connected to a needle through a Luer lock adaptor. A drying column filled with indicating Drierite was assembled into the dosing line to monitor the humidity of the stream. For regular dosing, CO₂ was directly bubbled through the solution. For dosing with controlled water amount, the regulator and the dosing line were evacuated under high vacuum overnight followed by backfilling with N₂. The N₂ was removed under high vacuum, and the line was backfilled with N₂. This process was repeated for a total of three high vacuum/backfill cycles. During evacuation, the pressure was made sure to reach ≤50 mTorr using a vacuum gauge. The dosing line was then purged with dry CO₂ for 1 min, and then CO₂ was bubbled through the MMNO solution inside the NMR tube with a vent needle attached at room temperature. After dosing, the NMR tube was removed, and the pierced screw cap was quickly swapped with a new one. The tube was then further sealed with electrical tape to prevent gas from escaping. The NMR spectra were obtained immediately after dosing.

¹³CO₂ Dosing. A ¹³CO₂ lecture bottle was connected to a Schlenk line through a 3-way valve, which was connected to a needle through a Luer lock adaptor. The dosing line was evacuated overnight with an empty screw-cap vial attached through the needle (not done for non-anhydrous dosing). The MMNO solution in the NMR tube was frozen in an ice-water bath (0° C.) for DMSO-D₆ and acetone-dry-ice bath (−78° C.) for D₂O. Then, with the dosing line backfilled with N₂, the frozen NMR sample was quickly attached through the needle. 3 cycles (for DMSO-D₆) and 1 cycle (for D₂O) of freeze-pump-thaw was then performed with N₂. During evacuation, the pressure was made sure to reach 100-200 mTorr using a vacuum gauge. After the last cycle, ¹³CO₂ (˜2.4 atm) was dosed into the thawed sample and allowed to equilibrate for 15 min at room temperature. After dosing, the NMR tube was removed, and the pierced screw cap was quickly swapped with a new one. The tube was then further sealed with electrical tape to prevent gas from escaping. The NMR spectra were obtained immediately after the dosing.

NMR Chemical Shift Perturbation Titration and Data Analysis. NMR Chemical Shift Perturbation Titration. Different concentrations of MMNO were studied to verify the validity of a single binding model under different conditions. Solutions of dried MMNO (1 equiv.) in dry DMSO-D₆ (0.5 mL, 0.125 M, 0.25 M, or 0.5 M) in screw-cap NMR tubes were prepared in a N₂-filled glovebox. The samples were then either dosed with ¹³CO₂ using the procedure outlined above or used directly. DI water (1, 2, 4, 6, 8, 10, 20, 40 equiv. for 0.125 M; 0.5, 1, 1.5, 2, 2.5, 5, 10, 20 equiv. for 0.25 M; 0.25, 0.5, 1, 1.5, 2, 2.5, 5, 10 equiv. for 0.5 M) was added quickly to the NMR tube with the cap opened using a microliter syringe, and then the cap was quickly closed. The mixture obtained at each titration point was shaken thoroughly for 1 min and allowed to equilibrate in the NMR probe for 5 min before the spectra were recorded. Proton resonances are referenced to residual protium in the NMR solvent (2.50 ppm for DMSO-D₆), assuming the added water would negligibly change its chemical shift.

The results from five different binding models were compared based on both quantitative analysis of goodness of the fit (see Table 1) and inspection of the residual plots. The analysis for the results showed that the experimental data fit best to the cooperative 1:2 stepwise binding model (1:2 full) (FIG. 2(e)) Therefore, H₂O more likely binds to MMNO with the following mechanism:

$$MMNO + {H}_{2} O ⇌ MMNO \cdot {H}_{2} O + {H}_{2} O ⇌ MMNO \cdot {( {H}_{2} O )}_{2}$$

TABLE 1
Features of the models used and results from
the fitting for NMR titration experiments.

| Binding | | | [MMNO]₀ | K₁ | K₂ | RMSₜₒₜ^{a} | Ratio |
|---|---|---|---|---|---|---|---|
| model | K₁ vs K₂ | δ_{ΔHG} vs δ_{HG}_{₂} | (M) | (M⁻¹) | (M⁻¹) | (10⁻³) | cov_{fit (tot)}^{b} |
| 1:1 | N/A | | 0.125 | 0.72 | | 3 | 20 |
| | | | 0.25 | 0.85 | | 3 | 189 |
| | | | 0.5 | 0.83 | | 3 | 325 |
| 1:2 | K₁ ≠ 4K₂ | δ_{ΔHG}_{₂} ≠ 2δ_{ΔHG} | 0.125 | 1.10 | 0.05 | 0.7 | 1 |
| full^{c} | | | 0.25 | 1.57 | 0.08 | 0.2 | 1 |
| | | | 0.5 | 1.64 | 0.05 | 0.2 | 1 |
| 1:2 | K₁ ≠ 4K₂ | δ_{ΔHG}_{₂} = 2δ_{ΔHG} | 0.125 | 1.43 | 0.15 | 3 | 19 |
| additive | | | 0.25 | 1.64 | 0.11 | 1 | 172 |
| | | | 0.5 | 1.78 | 0.11 | 3 | 301 |
| 1:2 | K₁ = 4K₂ | δ_{ΔHG}_{₂} ≠ 2δ_{ΔHG} | 0.125 | 1.16 | 0.29 | 1 | 3 |
| non- | | | 0.25 | 1.37 | 0.34 | 3 | 39 |
| cooperative | | | 0.5 | 1.22 | 0.31 | 1 | 57 |
| 1:2 | K₁ = 4K₂ | δ_{ΔHG}_{₂} = 2δ_{ΔHG} | 0.125 | 1.58 | 0.40 | 3 | 21 |
| statistical | | | 0.25 | 2.06 | 0.52 | 3 | 202 |
| | | | 0.5 | 2.58 | 0.65 | 3 | 380 |

^{a}RMSₜₒₜ = total root mean square for all the data points.
^{b}Ratio cov_{fit(tot)} = Relative total covariance of the fit of all the data points compared to that of the 1:2 full model.
^{c}The most plausible model.

In Situ IR Measurements (Simulated Vacuum Swing). CO₂ cycling experiments monitored by ReactIR were conducted in a room where the temperature was controlled by a thermostat, and the room temperature was always monitored and recorded with a digital thermometer (stabilized between 21-22° C.).

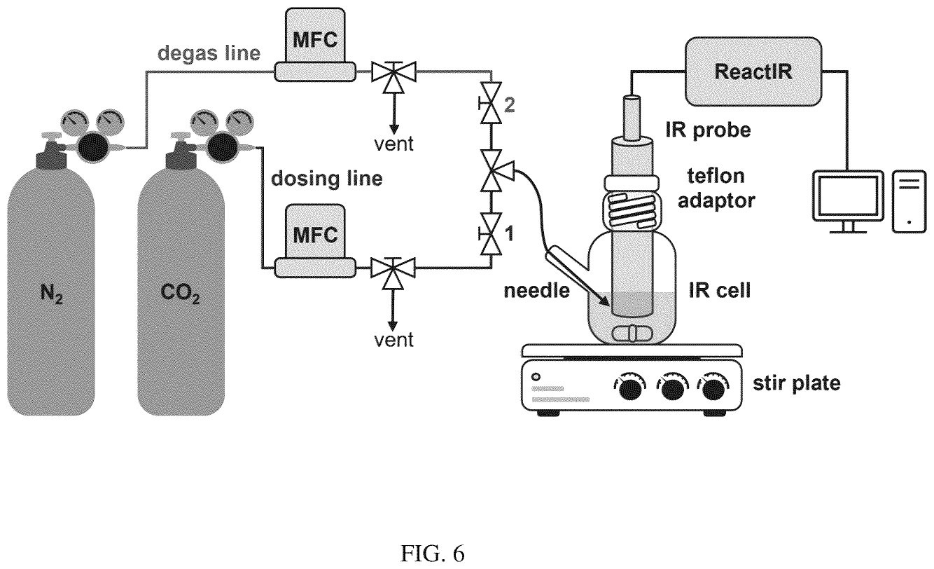

100%, 50%, 15% CO₂ Measurement. The dosing setup was assembled with Swagelok connections (see FIG. 6 for the flow scheme) with a steel needle attached on the end, and the flow rates were set to 6 sccm for both lines using Parker Series II mass flow controllers. Before each measurement, with valve 2 opened, the degas line was purged with N₂ for 2 minutes, then valve 2 was closed. The dosing line was then purged with CO₂ (100% bone dry grade, 50% in N₂ mixture, or 15% in N₂ mixture) with valve 1 opened until the measurement started.

Flue Gas Measurement. Two 200 mL syringes were purged with flue gas from the sample bag 3 times each and then charged with 200 mL flue gas. Metal needles were attached and sealed. A syringe pump equipped with the two 200 mL syringes charged with flue gas was set to 3 mL/min (min=minute(s)) (total of 6 mL/min) and then started pumping for 2 minutes to purge the dosing lines before the measurement started.

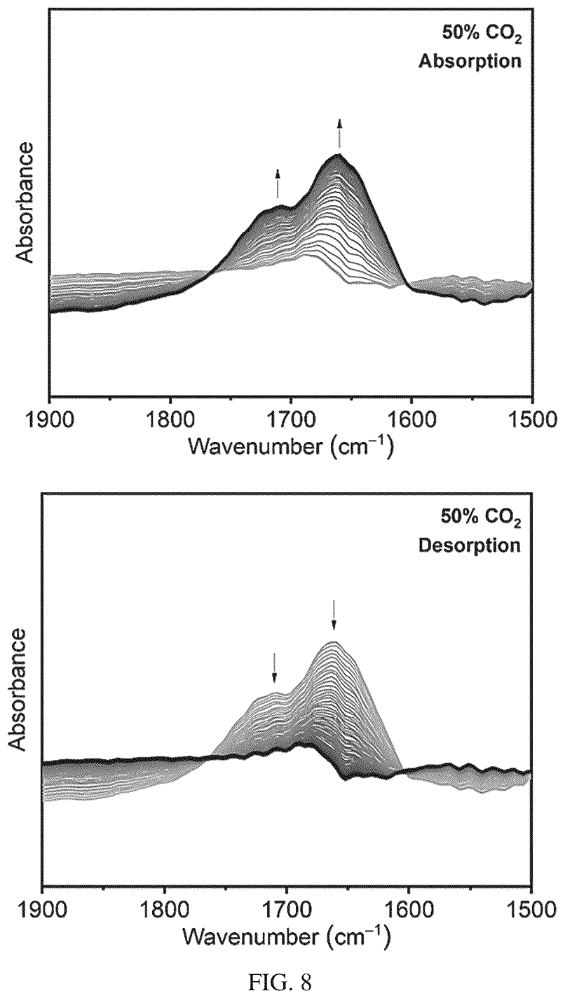

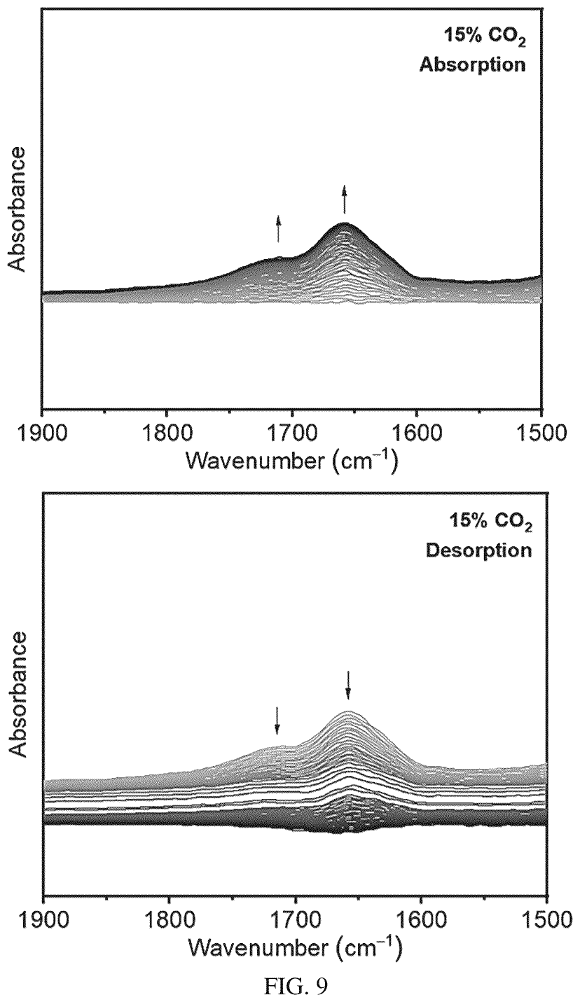

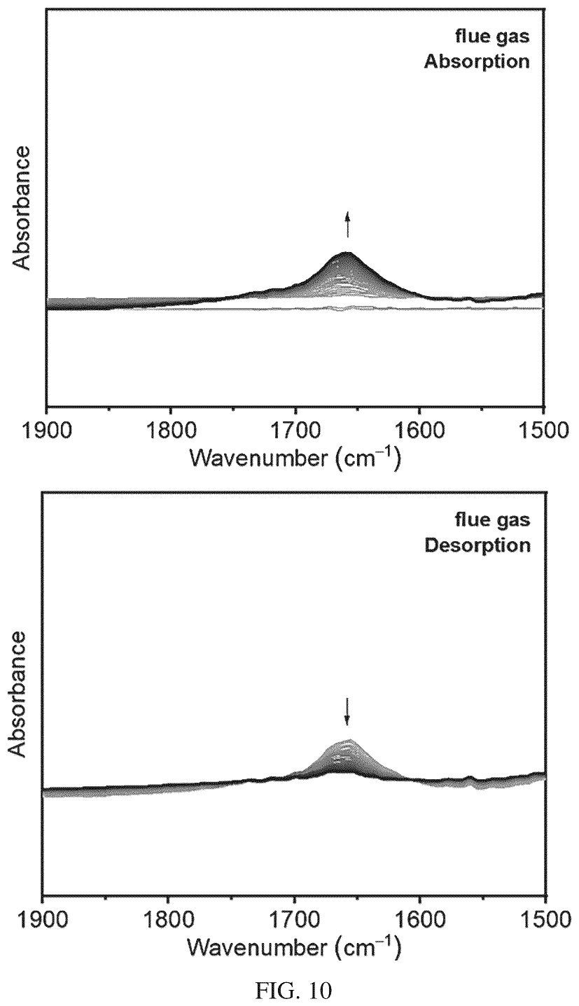

CO absorption and desorption was determined by IR. (FIGS. 8-10) During a typical experiment, the IR probe was inserted through a Teflon adapter and O-ring seal into an oven-dried custom-built IR cell with a side arm, which was then charged with 1 mL of 50 wt. % MMNO aqueous solution, 4 mL of DMSO, and a stir bar (1:4 volume ratio was chosen to optimize the signal and experiment time). The mixture was fully mixed for 5 min while all bubbles were removed. With continuing stirring, a 128-scan background was recorded, then the spectra were acquired at a speed of 4 spectra/min, a gain of 1×, and a resolution of 8 cm⁻¹ after the needle (in the case of flue gas, two needles) on the dosing line was inserted below the solution surface. After 1 hour of dosing, the needle was carefully removed from the solution, valve 1 was closed, valve 2 was opened, and after the flow stabilized, the needle was inserted into the solution again for desorption. CO₂ absorption and desorption were monitored by tracking the appearance and disappearance of the newly formed carbonyl species at 1656 and 1716 cm⁻¹, and spectra were obtained every 15 s. Due to the limitations of the instrumentation, it is difficult to use a high flow rate for CO₂; therefore, the reaction kinetics will be limited by the slow flow rate (6 sccm) of CO₂ bubbled through the solution.

VT ¹³C NMR (Simulated Temperature Swing). 1 M MMNO solution with 5 equivalents of water in DMSO-D₆ was dosed with ¹³CO₂ and variable temperature ¹³C{¹H} NMR spectra obtained. (FIG. 11)

Gravimetric Experiments. Gravimetric experiments were conducted in a room where temperature was controlled by a thermostat, and room temperature was always monitored and recorded with a digital thermometer (stabilized between 21-22° C.). Empty vials with septa caps were tared, and then 50 wt. % MMNO and DMSO were added via syringe. For control experiments, the same amounts of DI water and DMSO were added instead. The total masses were recorded, and then a 100%, 50% or 15% CO₂ in N₂ mixture was bubbled through the mixtures for 1 hour. After bubbling, the masses were recorded again. All experiments were conducted in triplicate. The experiment was conducted with different mixtures of MMNO, H₂O, and DMSO for comparison.

TABLE 2
Data for gravimetric experiments for 1:4 (v:v)
50 wt. % MMNO(aq):DMSO (5 mL total).

| CO₂ (% in N₂) | 100% | 50%^{a} | 15%^{a} |
|---|---|---|---|
| Control 1 solution (g) | 5.3481^{b} | 5.3454 | 5.3266 |
| Control 2 solution (g) | 5.3164 | 5.3615 | 5.3623 |
| Control 3 solution (g) | 5.2620 | 5.3724 | 5.3323 |
| Control 1 physisorbed CO₂ (g) | 0.0085 | −0.0017 | −0.0113 |
| Control 2 physisorbed CO₂ (g) | 0.0032 | −0.0003 | −0.0133 |
| Control 3 physisorbed CO₂ (g) | 0.0032 | −0.0026 | −0.0158 |
| Sample 1 solution (g) | 5.4287 | 5.4865 | 5.4938 |
| Sample 2 solution (g) | 5.4956 | 5.4960 | 5.5027 |
| Sample 3 solution (g) | 5.4643 | 5.5052 | 5.5049 |
| Sample 1 CO₂ (g) | 0.0651 | 0.0367 | 0.0091 |
| Sample 2 CO₂ (g) | 0.0631 | 0.0358 | 0.0110 |
| Sample 3 CO₂ (g) | 0.0636 | 0.0367 | 0.0098 |
| Average chemisorbed CO₂ (g) | 0.05897 | 0.0379 | 0.0234 |
| Average chemisorbed CO₂ | 2.3189 | 1.4770 | 0.9189 |
| capacity | | | |
| (mmol CO₂/g MMNO) | | | |
| Average chemisorbed CO₂ | 0.2717 | 0.1730 | 0.1077 |
| capacity | | | |
| (mmol CO₂/mmol MMNO) | | | |

^{a}Samples assumed to have the same amount of solvent loss as the controls.
^{b}The balance used for the measurement has a precision of 0.0001 g readability.

TABLE 3
Data for gravimetric experiments for 100% CO₂ (5 mL total)
with different mixtures of MMNO, H₂O, and DMSO.

| v:v (50 wt. % MMNO:DMSO) | 0.5:4.5 | 1:4 | 2:3^{a} |
|---|---|---|---|
| Control 1 solution (g) | 5.3331^{b} | 5.3481 | 5.2157 |
| Control 2 solution (g) | 5.3458 | 5.3164 | 5.2486 |
| Control 3 solution (g) | 5.3326 | 5.2620 | 5.2264 |
| Control 1 physisorbed CO₂ (g) | 0.0244 | 0.0085 | −0.0052 |
| Control 2 physisorbed CO₂ (g) | 0.0244 | 0.0032 | −0.0175 |
| Control 3 physisorbed CO₂ (g) | 0.0235 | 0.0032 | −0.0231 |
| Sample 1 solution (g) | 5.3862 | 5.4287 | 5.4192 |
| Sample 2 solution (g) | 5.2840 | 5.4956 | 5.4258 |
| Sample 3 solution (g) | 5.3937 | 5.4643 | 5.4219 |
| Sample 1 CO₂ (g) | 0.0574 | 0.0651 | 0.0509 |
| Sample 2 CO₂ (g) | 0.0560 | 0.0631 | 0.0523 |
| Sample 3 CO₂ (g) | 0.0560 | 0.0636 | 0.0521 |
| Average chemisorbed CO₂ (g) | 0.0324 | 0.05897 | 0.0670 |
| Average chemisorbed CO₂ | 2.8079 | 2.3189 | 1.3954 |
| capacity | | | |
| (mmol CO₂/g MMNO) | | | |
| Average chemisorbed CO₂ | 0.3289 | 0.2717 | 0.1634 |
| capacity | | | |
| (mmol CO₂/mmol MMNO) | | | |

^{a}Samples assumed to have the same amount of solvent loss as the controls.
^{b}The balance used for the measurement has a precision of 0.0001 g readability.

Calibration Curve of IR. Using the IR signal at 1656 cm⁻¹ in conjunction with gravimetrically measured chemisorbed capacities from 100%, 50%, and 15% CO₂ streams, calibration curves were built according to the Beer-Lambert law.

Stability of MMNO. Accelerated Aging Studies. The stability of MMNO as a representative N-oxide and MM, MP, and MEA as representative amines in both water and wet DMSO was evaluated by heating a solution of each in either D₂O or DMSO-D₆ (0.25 M for both) at 100° C. in air or in flue gas for up to 1 week (168 hours). This accelerated degradation experiment mimics many industrial cycles. The retention of each molecule under both conditions was evaluated by ¹H NMR afterwards. For flue gas aging studies, solutions were pre-saturated with flue gas by slowly bubbling 50 mL flue gas through before heating.

Viscosity Measurements. The viscosity of 1:4 (v:v) 50 wt % MMNO(aq):DMSO with a shear rate of 300 s⁻¹ at various temperatures before and after CO₂ bubbling was measured. (FIG. 12)

In situ pH Measurements. In situ pH measurements of pure water and aqueous MMNO solution (0.25 M, both 6 mL) when bubbling 100% CO₂ through the solutions. (FIG. 13)

### Example 2

This example provides a description of methods, compositions, and systems of the present disclosure.

Use of tertiary amine N-oxide group functionalized metal organic frameworks (MOFs) as carbon dioxide capture sorbent material(s) was demonstrated.

Based on desirable retention of PXRD patterns after soaking in a solution of MMNO, MOF-808 showed desirable stability and was used as a capture sorbent material.

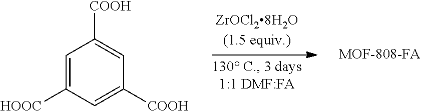 [SMILES: O=C(O)c1cc(C(=O)O)cc(C(=O)O)c1]

Synthesis procedure (MOF-808-FA). Trimesic acid (2 g) and ZrOCl₂·8H₂O (4.6 g, 1.5 equiv.) were dissolved in dimethyl formamide (DMF) (214 mL) and formic acid (FA) (214 mL) in a 1 L round-bottom high-pressure vessel to get a clear solution. Two batches of the same-scale reaction were set up, and the vessels were sealed and put into a preheated explosion-proof oven at 130° C. and heated for 3 days. After the reactions were done, they were cooled to room temperature and reaction vessels were carefully opened inside a fume hood to release the pressure. Then 2 batches of MOF product were combined and isolated by centrifuge at 6000 rpm for 30-45 min. Then combined MOF product was washed in a jar with 600 mL DMF at 130° C. for 4×24 h followed by 600 mL 200-proof EtOH at 75° C. for 3×24 h in an oven. After the final round of wash and solvent was removed, MOF product was suspended in some MeCN to help with filtration. MOF product was then vacuum filtered and washed with some MeCN on filter paper, dried in air, and then activated at 110° C. under a dynamic vacuum (less than 50 mTorr) for 24 h (h=hour(s)) before being brought to a N₂-filled glovebox for storage.

Digestion procedure (MOF-808-FA). ˜5 mg of MOF-808-FA was suspended in 0.5 mL of DMSO-D₆ in a 4 mL scintillation vial and 5-8 drops of D₂SO₄ were added to the suspension. The suspension was sonicated for 2 min and then heated to 100-105° C. for overnight until everything was dissolved to make a clear solution. Then the clear solution was cooled to room temperature and transferred to an NMR tube for analysis.

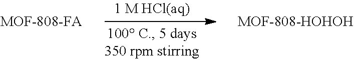

Synthesis procedure (MOF-808-HOHOH). In a 1 L round-bottom high-pressure vessel, activated MOF-808-FA (1.12 g) was suspended in 600 mL 1 M HCl. A stir bar was added, and the reaction vessel was sealed and heated to 100° C. in an oil bath (protected by a splash shield) for 5 days with a stirring speed of 350 rpm. After the reaction was done, MOF product was collected by centrifuge at 6000 rpm for 30-45 min (min=minute(s)). After the supernatant was removed by decanting, 500 mL of fresh DI water was added to the centrifuge bottle, followed by sonication to resuspend the MOF, then re-centrifuged. This procedure was repeated 3 times to wash the MOF. After the last round of wash and water was decanted, some MeCN was added to suspend the MOF, which was vacuum filtered, and washed with some MeCN on filter paper, dried in air, and then activated at 120° C. under a dynamic vacuum (less than 50 mTorr) for 24 h before being brought to a N₂-filled glovebox for storage.

Digestion procedure (MOF-808-HOHOH). ˜5 mg of MOF-808-HOHOH was suspended in 0.5 mL of DMSO-D₆ in a 4 mL scintillation vial and 5-8 drops of D₂SO₄ were added to the suspension. The suspension was sonicated for 2 min and then heated to 100-105° C. for overnight until everything was dissolved to make a clear solution. Then the clear solution was cooled to room temperature and transferred to an NMR tube for analysis. Displacement of formic acid was determined from the disappearance of formic acid peak in ¹H NMR spectrum.

Synthesis procedure (MOF-808-HOHOH—N-oxides). Inside a N₂-filled glovebox, activated MOF-808-HOHOH (˜25-50 mg) was suspended in a solution of anhydrous N-oxides (5-10 equiv. vs. HOHOH sites) in anhydrous MeCN (2-5 mL) at room temperature for 24 h. Then the MOF was filtered inside the glovebox and washed with 2-5 mL of anhydrous MeCN before being stored inside glovebox for further analysis.

Digestion procedure (MOF-808-HOHOH—N-oxides). ˜5 mg of MOF-808-HOHOH—N-oxides was suspended in 0.3 mL D₂O+0.3 mL saturated solution of K₃PO₄ in D₂O in a 4 mL scintillation vial, sonicated for 5-10 min to obtain a clear solution. Then the clear solution was transferred into an NMR tube for analysis. The N-oxide loading was determined by integrating the peak corresponding to trimesic acid as well as the N-oxides in ¹H NMR spectrum. The following N-oxides were tested:

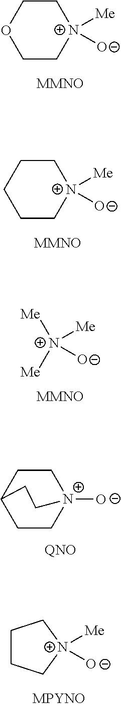

methyl morpholine N-oxide (MMNO), trimethyl amine N-oxide (TMANO), quinuclidine N-oxide (QNO), and methyl pyrrolidine N-oxide (MPYNO).

Purification procedure (TMANO). Commercial TMANO was purified and dried via vacuum sublimation at 85° C. and then brought into a N₂-filled glovebox for storage.

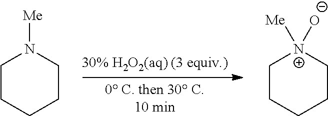 [SMILES: CN1CCCCC1 ; C[N+]1([O-])CCCCC1]

Synthesis procedure (MPNO). In a 20 mL scintillation vial, combined methyl piperidine (2.5 mL) and a thoroughly cleaned stir bar. After the vial was cooled to 0° C. in an ice bath, 30% H₂O₂ aqueous solution (6.3 mL) was added slowly. While keeping the cap loose, the reaction mixture was stirred and heated to 30° C. for 10 min. After the reaction was done, cooled the reaction to room temperature and then to 0° C. in an ice bath. A catalytic amount of MnO₂ was added slowly with stirring. After the heat and gas generation ceased, reaction mixture was left at room temperature with loose cap for 24 h. MnO₂ was removed by filtration through a celite pad to yield a pinkish solution. The reaction mixture was tested with peroxide testing strips to make sure of a hydrogen peroxide level of less than 1 mg/L. The solution was air-dried overnight. The product was then purified and dried by 2 rounds of vacuum filtration at 100° C. and less than 50 mTorr to yield a crystalline white solid, which was then brought into a N₂-filled glovebox for storage.

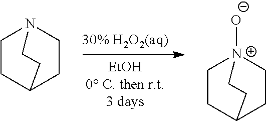 [SMILES: C1CN2CCC1CC2 ; [O-][N+]12CCC(CC1)CC2]

Synthesis procedure (QNO). In a round bottom flask equipped with a thoroughly cleaned stir bar, quinuclidine (lg) was dissolved in EtOH (12.5 mL) and then solution was cooled to 0° C. in an ice bath. 30% H₂O₂ aqueous solution (12.5 mL) was added slowly. After addition, the solution was warmed to room temperature and stirred at room temperature for 3 days with a loose cap. After the reaction was done, reaction mixture was cooled down to 0° C. in an ice bath. A catalytic amount of MnO₂ was added carefully and slowly with stirring. CAREFUL! Rigorous bubbling! After bubbling ceased, warm to room temperature and stirred for 24 h with loose cap. MnO₂ was removed by filtration through a celite pad. Then the reaction mixture was tested with peroxide testing strips to make sure of a hydrogen peroxide level of less than 1 mg/L. Product was air-dried overnight to remove most of the solvent to yield a clear semicrystalline solid. Product was purified and dried by 2 rounds of vacuum sublimation at 120° C. and less than 50 mTorr. After the sublimation was done in 4-5 h, the semi-transparent milky crystalline product was brought into a N₂-filled glovebox for storage.

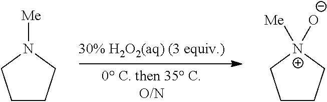 [SMILES: CN1CCCC1 ; C[N+]1([O-])CCCC1]

Synthesis procedure (MPYNO). In a 40 mL scintillation vial, combined methyl pyrrolidine (2 g) and a thoroughly cleaned stir bar. After the vial was cooled to 0° C. in an ice bath, 30% H₂O₂ aqueous solution (10 mL) was added slowly to yield a murky whitish solution. While keeping the cap loose, the reaction mixture was stirred and heated to 35° C. for overnight. After the reaction was done, cooled the reaction to room temperature and then to 0° C. in an ice bath. A catalytic amount of MnO₂ was added slowly with stirring. After the heat and gas generation ceased, reaction mixture was left at room temperature with loose cap for 24 h. MnO₂ was removed by filtration through a celite pad. Then the reaction mixture was tested with peroxide testing strips to make sure of a hydrogen peroxide level of less than 1 mg/L. The resulting orange solution was air-dried overnight to yield an orange oil. The product was then purified and dried by 2-4 rounds of vacuum filtration (the product turns liquid first during heating) at 90° C. and less than 50 mTorr to yield a crystalline white solid, which was then brought into a N₂-filled glovebox for storage.

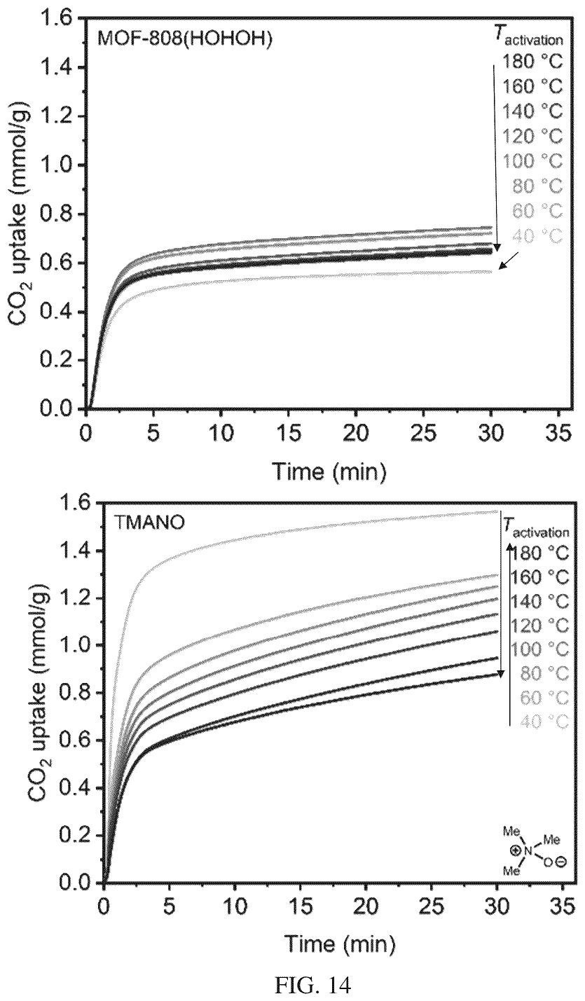

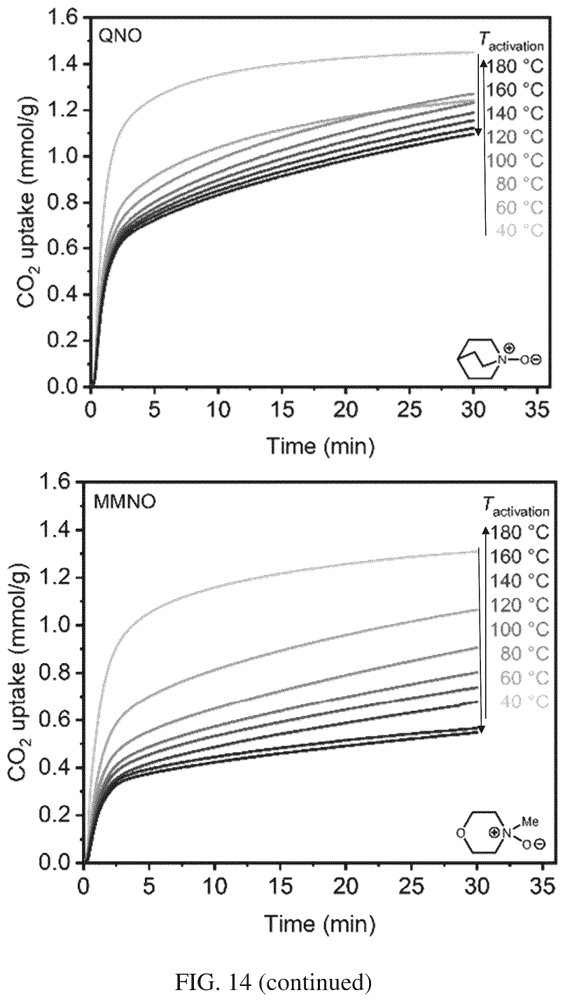

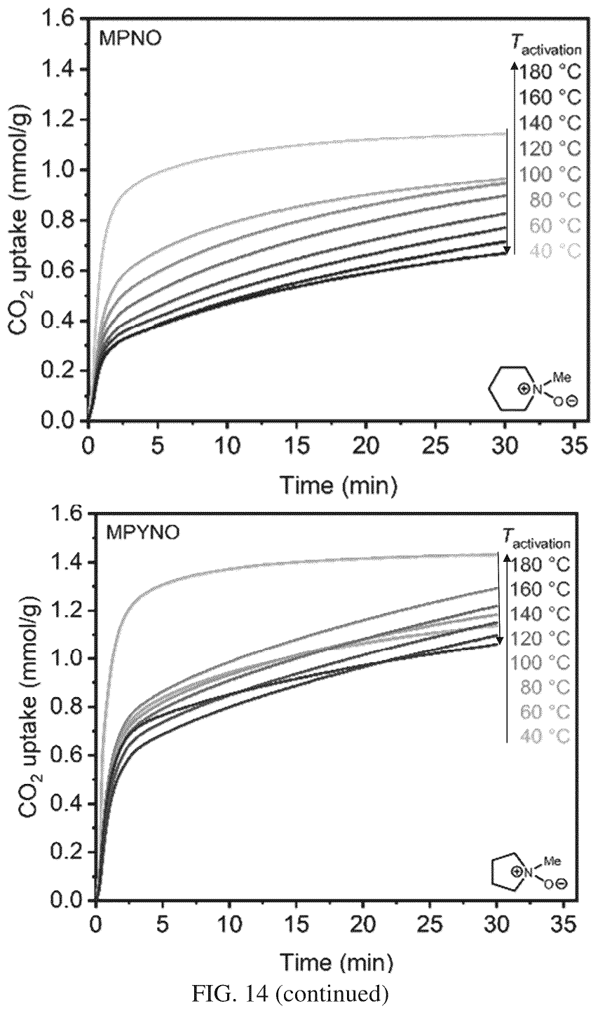

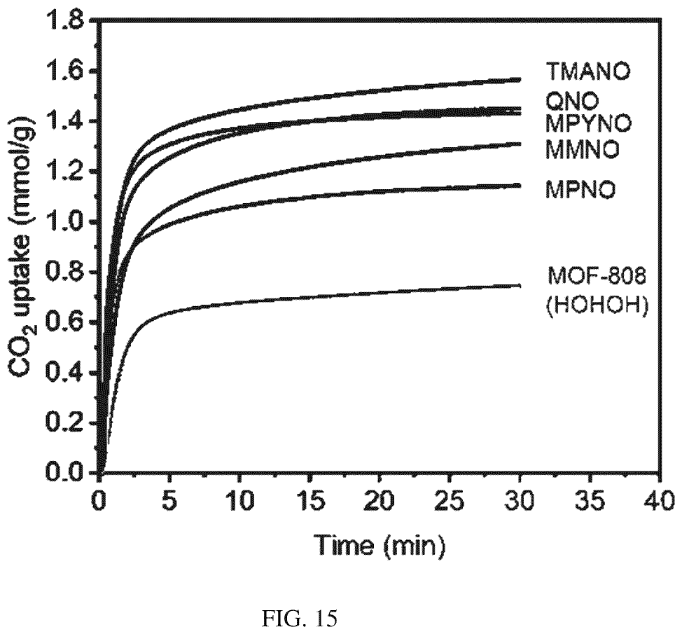

TGA analysis. Measurements were conducted with a flow rate of 60 mL/min. To find desirable activation temperature (T_{activation}) for each MOF, CO₂ adsorption profiles at 30° C. were measured by TGA for each MOF after exposure to a flow of dry N₂ for 120 min at varying temperatures. All MOFs were taken out from glovebox and quickly loaded onto TGA under air. The optimal activation temperature to maximize the adsorption capacity for each MOF was determined to be 100° C. for MOF-808-HOHOH, 40° C. for all N-oxide-appended MOFs (MOF-808-HOHOH-TMANO/QNO/MPYNO/MMNO/MPNO). The CO₂ uptake profile for each material at these activation temperatures are shown in FIG. 14. Under desirable activation conditions, all of the N-oxides appended MOFs showed better CO₂ adsorption capacity than the parent MOF-808-HOHOH, with MOF-808-HOHOH-TMANO showed double the CO₂ capacity compared to that of MOF-808-HOHOH (FIG. 15).

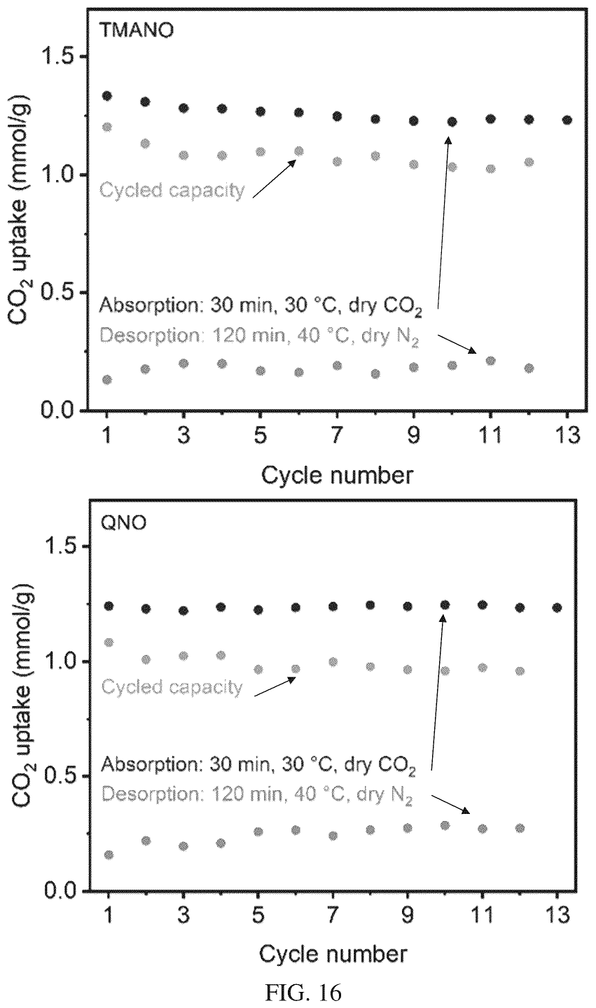

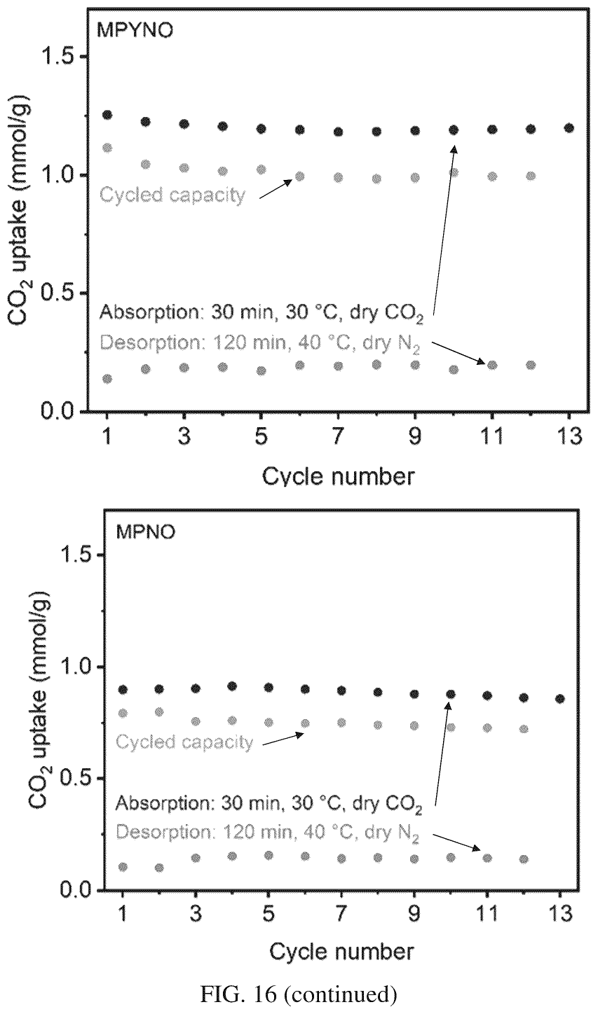

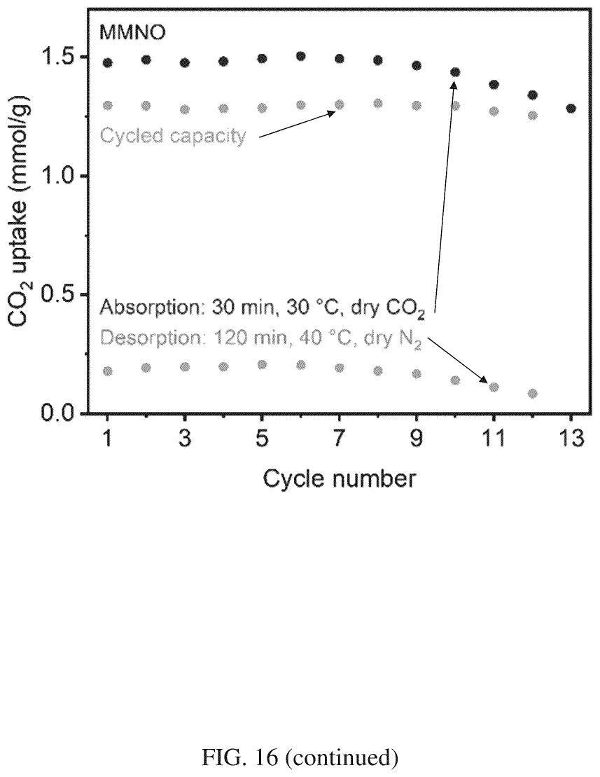

To test the cyclability, N-oxide-appended MOFs were activated by exposure to a flow of dry N₂ for 720 min at 40° C. before CO₂ capacity measurements. (FIG. 16).

TABLE 4
Summary of performance screening for N-oxide-appended
MOFs (MOF-808-HOHOH-TMANO/QNO/MPNO/MPYNO/MMNO).

| | N-oxides:trimesic acid^{a} | | | | | | |
|---|---|---|---|---|---|---|---|
| | | TGA | | avg. uptake | % retention | | |
| | | 40° C. N₂ | TGA | 12 cycles | cycle 12 vs. | Color after | |
| N-oxides | Soaking | 12 h | cycling | (mmol/g) | cycle 3 | cycling | Notes |
| MMNO | 2.41 | 2.36 | 2.27 | 1.29 | 98.05 | light | decompose |
| | | | | | | orangish | |
| MPNO | 1.65 | 1.67 | 1.68 | 0.75 | 95.41 | light | low uptake |
| | | | | | | yellowish | |
| TMANO | 2.04 | 2.05 | 2.02 | 1.08 | 97.34 | white | cheap/high |
| | | | | | | | uptake |
| QNO | 1.49 | 1.51 | 1.5 | 0.99 | 93.67 | white | slightly |
| | | | | | | | irreversible |
| MPYNO | 1.83 | 1.86 | 1.93 | 1.02 | 96.76 | white | low |
| | | | | | | | retention |

^{a}Ratios determined by MOF digestion ¹H NMR.

TABLE 5
Summary of soaking conditions for 25 mg MOF and resulting
TMANO:trimesic acid ratios for MOF-808-HOHOH-TMANO.

| soaking conditions in glovebox | | | |
|---|---|---|---|
| Time after 24 h | TMANO | MeCN | TMANO:trimesic |
| soaking | (vs. HOHOH sites) | (mL) | acid^{a} |
| 0 days^{b} | 5 equiv. | 2.5 | 2.05 |
| | | 2 | 1.94 |
| | | 1 | 2.18 |
| | 10 equiv.. | 2 | 2.07 |
| 52 days^{b} | 5 equiv. | 2.5 | 1.98 |

^{a}Ratios determined by MOF digestion ¹H NMR.
^{b}MOFs were stored in glovebox for X days after they were filtered after 24 h soaking.
^{b}MOFs were stored in glovebox for X days after they were filtered after 24 h soaking.

As shown in Tables 4 and 5, the performance of MOF-808-HOHOH—N-oxides (e.g., based on TGA measurements including the CO₂ uptake, cycling % retention, visual color change, and notes) MOF-808-TMANO was the most promising analog. The grafting of TMANO was then carried out under different conditions to obtain a desired TMANO:trimesic acid ratio.

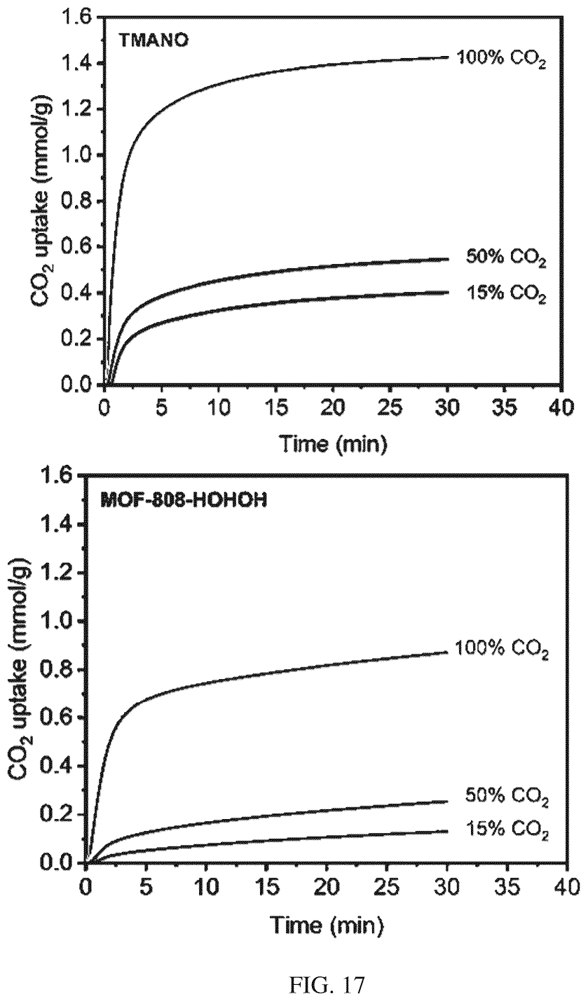

Custom blends of CO₂ in N₂ were prepared using a Blended Gas Delivery Module. MOFs were activated at desirable activation temperatures for 300 min before CO₂ capacity measurements (FIG. 17).

Although the present disclosure has been described with respect to one or more particular example(s), it will be understood that other example(s) of the present disclosure may be made without departing from the scope of the present disclosure.

1. A method of separating, capturing, sequestering, or storing, or any combination thereof, carbon dioxide (CO₂), one or more structural analog(s) thereof, or a combination thereof comprising:
contacting a gas comprising the CO₂, the one or more structural analog(s) thereof, or the combination thereof or a liquid comprising the CO₂, the one or more structural analog(s) thereof, or the combination thereof with water and one or more capture sorbent(s) independently comprising one or more tertiary amine N-oxide(s) and/or one or more tertiary amine N-oxide group(s), wherein at least a portion, substantially all, or all of the CO₂, the one or more structural analog(s) thereof, or the combination thereof is separated, captured, sequestered, or stored, or any combination thereof.

2. The method of claim 1, wherein the one or more tertiary amine N-oxide(s) and/or the one or more tertiary amine N-oxide group(s) independently comprise: 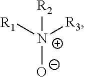
a structural analog thereof, a hydrate thereof, or a group formed therefrom, wherein:
R₁ is chosen from —H, alkyl groups, and aryl groups;
R₂ and R₃ are independently chosen from alkyl groups, and aryl groups; and/or
one or more of R₁ and R₂, R₁ and R₃, R₂ and R₃, or R₁, R₂, and R₃ form a ring or rings.

3. The method of claim 1, wherein the one or more tertiary amine N-oxide(s) and/or the one or more tertiary amine N-oxide group(s) independently comprise: 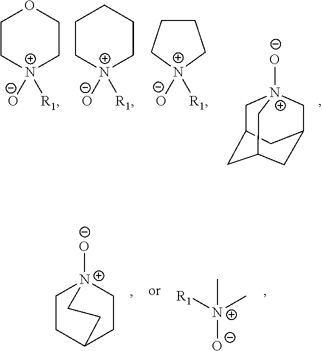
a structural analog thereof or a hydrate thereof, or a group formed therefrom.

4. The method of claim 2, wherein R₁ is 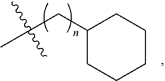
wherein n is 1, 2, 3, 4, 5, 6, 7, or 8, or 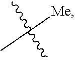
or a structural analog thereof.

5. The method of claim 1, wherein one or more or all of the one or more capture sorbent(s) comprises the one or more tertiary amine N-oxide group(s) attached to at least a portion, substantially all, or all of one or more solid material(s).

6. The method of claim 1, wherein the one or more tertiary amine N-oxide(s) the one or more tertiary amine N-oxide group(s) is/are formed prior to or during the contacting.

7. The method of claim 1, further comprising desorbing or re-forming at least a portion of, substantially all of, or all of the separated, the captured, the sequestered, or the stored CO₂, the stored structural analog(s) thereof, or the combination thereof.

8. The method of claim 7, wherein desorbing further comprises contacting the separated, the captured, the sequestered, or the stored carbon dioxide, the stored structural analog(s) thereof, or the combination thereof with a gas, such that a partial pressure of CO₂ is less than about 15% and/or reducing the pressure of the gas comprising the carbon dioxide or the structural analog(s) thereof or subjecting a mixture of the gas comprising the carbon dioxide or the structural analog(s) thereof, the water, and the capture sorbent(s) comprising the one or more tertiary amine N-oxide(s) and/or the one or more tertiary amine N-oxide group(s) to reduced pressure.

9. The method of claim 1, wherein the method is carried out at a temperature of about 20 to about 25° C.

10. The method of claim 1, wherein the pH of the water and/or one or more or all of the one or more capture sorbent(s) is from about 6 to about 9.

11. The method of claim 1, wherein the contacting comprises contacting the gas comprising the CO₂, the structural analog(s) thereof, or the combination thereof or a liquid comprising the CO₂, the structural analog(s) thereof, or the combination thereof with the water and one or more co-solvent(s).

12. The method of claim 11, wherein the one or more co-solvent(s) is/are chosen from DMSO, N-methyl pyrrolidone (NMP), acetonitrile (CH₃CN), methanol (MeOH), structural analogs thereof, and any combination thereof.

13. The method of claim 1, wherein the gas comprising the CO₂, the structural analog(s) thereof, or the combination thereof is a waste gas, an industrial gas, or any combination thereof or the liquid comprising the CO₂, the structural analog(s) thereof, or the combination thereof is a waste stream, an industrial stream, or any combination thereof.

14. The method of claim 1, further comprising repeating the contacting a desired number of times, wherein at least a portion, substantially all, or all of the one or more tertiary amine N-oxide(s) and/or the one or more tertiary amine N-oxide group(s), optionally, water, and/or optionally, one or more organic solvent(s) is/are used in each of the repeated contacting(s).

15.-18. (canceled)

19. The method of claim 1, wherein at least a portion, substantially all, or all of the one or more tertiary amine N-oxide group(s) is/are attached to at least a portion, substantially all, or all of one or more surface(s) of one or more polymeric material(s) and/or one or more amorphous material(s) and/or one or more crystalline material(s).

20. The method of claim 19, wherein at the one or more crystalline material(s) are independently chosen from silica frameworks, aluminosilicate frameworks, covalent-organic frameworks, and metal-organic frameworks.

21. The cm method of claim 19, wherein the one or more polymeric material(s) and/or one or more crystalline material(s) independently comprise 0.001 percent to about 50 percent by weight of the tertiary amine N-oxide group(s).

22.-23. (canceled)

24. The method of claim 5, wherein the one or more of the solid material(s) is/are one or more polymeric material(s) and/or one or more amorphous material(s) and/or one or more crystalline material(s) and the one or more polymeric material(s) and/or the one or more amorphous material(s) and/or the one or more crystalline material(s) are one or more porous polymeric material(s) and/or one or more porous amorphous material(s) and/or one or more porous crystalline material(s) that independently comprise (i) a pore sire range of about 1 nm to about 50 nm and/or (ii) a surface area of about 0.001 m²/g to about 10,000 m²/g and/or (iii) 0.001 percent to about 50 percent by weight of the tertiary amine N-oxide group(s).

25.-28. (canceled)

29. The method of claim 1, wherein the one or more capture sorbent(s) does/do not decompose or exhibits about 5% or less decomposition after about 0 days to about 1 week at about 95 to about 100° C.

30.-34. (canceled)

35. A capture sorbent composition, comprising one or more tertiary amine N-oxide(s) and/or one or more tertiary amine N-oxide group(s).
